(19) United States
(12) Patent Application Publication
(10) Pub. No.: US 2023/0071141 A1
(43) Pub. Date: Mar. 9, 2023

(54) Home Compostable Label

(71) Applicant: Sinclair Systems International, LLC, Fresno, CA (US)

(72) Inventors: Wen-Li A. Chen, Woodstock, GA (US); M. Scott Howarth, Fresno, CA (US)

(21) Appl. No.: 17/886,817

(22) Filed: Aug. 12, 2022

Related U.S. Application Data
(60) Provisional application No. 63/232,875, filed on Aug. 13, 2021.

(51) Int. Cl. C08L 67/02; G09F 3/02; C08L 67/04; C08L 3/02

(52) U.S. Cl. CPC C08L 67/02; G09F 3/02; C08L 67/04; C08L 3/02; G09F 2003/0223; G09F 2003/0257; C08L 2201/06; C08L 2203/16

(57) ABSTRACT

The present disclosure relates to a home compostable label and its facestock, and a method for manufacturing such label and facestock. The facestock comprises a core layer comprising a top surface, a bottom surface, and a core compostable material; and a first skin layer comprising a first compostable material, said first skin layer being positioned proximate to at least a portion of the top surface of the core layer.

### CROSS-REFERENCE TO RELATED APPLICATION

This application claims priority to U.S. Patent Application No. 63/232,875, filed Aug. 13, 2021, the disclosure of which is incorporated by reference herein in its entirety.

### FIELD OF THE INVENTION

The present disclosure relates generally to home compostable labels and their facestocks. The home compostable labels may be used for labeling a wide variety of such as packaging and produce (inclusive of directly labeling fruits and vegetables).

### BACKGROUND OF THE INVENTION

The increasing addition of non-degradable and non-compostable materials to our environment and our municipal solid waste streams is drastically effecting the quality of our environment and reducing the number of landfills available as well as increasing the costs associated with municipal solid waste disposal. While the recycling of reusable components of the waste stream is desirable, it is not always effective and/or efficient to certain types of waste.

Composting is the ideal solution for the disposal of the organic component of urban waste. Substances such as leftover food, kitchen scraps, garden waste, waste from canteens and restaurants are rich in water and decompose quickly. Consequently they are not suitable for recovering energy through incineration because heat is lost in evaporating water rather than in producing electricity. In landfill sites, wet organic waste causes serious environmental problems, such as methane production, and can contaminate water tables through contaminated percolates. The production of compost and its use in agriculture represent the closure of the environmental cycle and constitute a simple way to address the problem caused by the removal of organic substances from agricultural soils, reduced soil fertility and the onset of desertification, particularly in Western countries. After being taken from the fields to our supermarkets, organic matter is returned to its place of origin in the form of compost, a substance that helps maintain soil fertility, prevents erosion, reduces the leaching of inorganic fertilizers, and obstructs the development of micro-organisms that are pathogenic for plants. Compositing of separately collected organic waste from households, such as kitchen and garden waste, is usually conducted by municipalities in industrial composting facilities.

Home composting can complement industrial composting. Home composting lowers the volumes of waste collected from households, and thus may lead to reduced waste disposal costs. Home composting also produces compost for private gardening use.

Currently, there are several national and international standards for compostability. Industrial compostability standards include ASTM D6400:2000, standard specification for compostable plastics; and EN 13432, requirements for packaging recoverable through composting and biodegradation. Home compostability standards include Australian Standard AS 5810-2010 (“AS5810”), biodegradable plastics suitable for home composting; French standard NFT 51-800, plastics—specifications for plastics suitable for home composting; and TÜV Austria OK compost HOME (“EN13432 Modified”), which is based on EN 13432.

### BRIEF SUMMARY OF THE INVENTION

The present invention provides home compostable labels, which may be used in a wide variety of labeling or tracking applications, such as packaging components and product labeling. These labels can be used for labeling produce by being applied to the packaging and/or directly on the produce (e.g., fruits and/or vegetables). The labels may be home compostable labels that are food-safe, for application directly on the surface of fresh produce (inclusive of edible skin produce) and may comprise partially, predominately and fully compostable facestock, inks, adhesives and/or backing paper, in particular, in certain embodiments any one or more of the label components may be home compostable including the facestock as well the facestock plus the adhesive and/or the facestock plus the ink and additionally the backing paper. The home compostable label may conform to the contours and/or shape of the item (e.g., item of produce) and readily be removed without leaving adhesive residue. The home compostable label may be configure to be easily applied, inclusive of with high-speed labeling machines, suitably adhered to the produce through the rigors of handling, shipping and retail delivery while also being easy to remove (e.g., by lifting the label off by hand) without leaving an adhesive residue. The home compostable label may also be suitable for a high-speed, tray, compact pattern and/or on-line applications. The home compostable label may include labels wherein the largest dimension is less than 2 inches, for example less than 1 inch or less than 0.75 of an inch to larger labels wherein the largest dimension exceeds 2 inches, for example larger than 2.5 inches or larger than 2.8 inches or 2.9 inches and larger. The home compostable label may be suitable for direct application on melons, pumpkins, squash, avocados, citrus, peppers, mangoes, oranges, apples, bananas, cantaloupes, pears, potatoes, onions, peaches, lettuce, root vegetables, carrots, herbs, as well as packaging for the same or similar items in a manner that is suitably gentle to offer effective adherence without damage to the item either during application or removal or any point in between. The home compostable labels may be suitable for tabbed or untabbed labels, inclusive of direct-thermal printed tabbed or untabbed labels, as well as for print on one-side or both-sides. The home compostable label may also be a clear label, for example a clear label able to receive a graphic, image, and/or text or otherwise secure the same on an item, for example the item of produce of the types noted above. The home compostable label may be configured for printing of variable information on the label at or proximate the point of application to the item, for example the item of produce of the types noted above. The home compostable label may be configured such that when it is applied to an item, for example the item of produce of the types noted above, it communicates one or more of the following types of information, for example, price look up (PLU) code, lot code, dates, UPC code, bar code, GS1 databar, 2D code, Datamatrix, QR code, information or date about the item and/or producer, location, country of origin, trademarks and/or trademark information or design, type of item, condition of item, or any combination of any or all of the above. The home compostable label may be a micro-thin direct application label.

Certain embodiments may provide, for example, a facestock for a home compostable label comprising a core layer. Certain embodiments may provide, for example, a facestock of a home compostable label comprising: i) a core layer; and ii) a first skin layer that are either or both home compostable.

A. In certain embodiments, for example, the core layer comprises a top surface and a bottom surface. In certain embodiments, for example, the core layer has a thickness that is 60 to 90% of the facestock's thickness. In certain embodiments, for example, the core layer has a thickness of 20 to 60 microns.

B. In certain embodiments, for example, the core layer comprises a core home compostable material. In certain embodiments for example, the core home compostable material is selected from a group containing or comprising biodegradable polymers, including linear and/or branched aliphatic, linear and/or branched aromatic polyesters and linear and/or branched aromatic/aliphatic copolyesters and polyamides, and mixtures thereof. In certain embodiments, suitable composition comprising polymers may include polybutylene succinate (PBS), polybutylene succinate adipate (PBSA), polyhdroxyalkanoates (PHA's) such as polyhydroxybutyrate (PHB), polyhydroxybutyrate valerate (PHBV)), polyhydroxy butyrate co-hexanoate (PHBH), polycaprolactone (PCL), polybutylene adipate terephthalate (PBAT), branched PBAT copolyesters, polybutylene succinate adipate (PBSA), polylactic acid (PLA), polycaprolactone (PCL), and other thermoplastic materials such as those containing starch, such as natural potato starch with biologically sourced polymers (for example, natural potato starch with 60-90 wt. % biodegradable carrier polymer, including aliphatic, aromatic and linear and/or branched aromatic/aliphatic copolyesters and polyamides, such as polybutylene succinate (PBS), polybutylene succinate adipate (PBSA), polyhdroxyalkanoates (PHA's) such as polyhydroxybutyrate (PHB)), polyhydroxybutyrate valerate (PHBV), polyhydroxy butyrate co-hexanoate (PHBH), polycaprolactone (PCL), and preferably polybutylene adipate terephthalate (PBAT), most preferably branched PBAT copolyesters such as Ecoflex, produced by BASF, biodegradeable materials available from Biome Bioplastics such as Biome 300 and mixtures thereof. In certain embodiments, the polymer composition used in the home compostable composition may comprise a carrier polymer present in the range 50%-80% by weight of the polymer composition, more preferably 55%-75% by weight of the polymer composition, and most preferably the carrier polymer may comprise from 60%-75% by weight of the polymer composition with the balance being natural potato starch or mostly, natural potato starch, for example at least 20% by weight natural potato starch.

In certain embodiments, for example, the core home compostable material comprises from 1% to 99%, or 1% to 25% or 10% to 45%, or 15% to 35%, or 20% to 70% by weight of a home compostable polymer (which may be a blend of polymers) such as polybutylene adipate terephthalate (PBAT) or any of the above-noted polymers, polymer blends or polymer compositions. In certain embodiments, for example, the core home compostable material comprises from 1% to 99%, or 1% to 25% or 10% to 45%, or 15% to 35%, or 20% to 70% by weight 25% to 99% by weight of polybutylene succinate (PBS). In certain embodiments, for example, the core home compostable material comprises from 1% to 99%, or 1% to 25% or 10% to 45%, or 15% to 35%, or 20% to 70% by weight of polybutylene succinate adipate (PBSA). In certain embodiments, for example, the core home compostable material comprises from 1% to 99%, or 1% to 25% or 10% to 45%, or 15% to 35%, or 20% to 70% by weight of polylactic acid (PLA). In certain embodiments, for example, the core home compostable material comprises from 1% to 99%, or 1% to 25% or 10% to 45%, or 15% to 35%, or 20% to 70% by weight of a mixture of polybutylene adipate terephthalate (PBAT) (55%) and polylactic acid (PLA) 45%. In certain embodiments, for example, the core compostable material comprises from 1% to 99%, or 1% to 25% or 10% to 45%, or 15% to 35%, or 20% to 70% by weight of a mixture of polybutylene adipate terephthalate (PBAT) and polylactic acid (PLA). In certain embodiments, for example, the core compostable material comprises from 1% to 99%, or 1% to 25% or 10% to 45%, or 15% to 35%, or 20% to 70% or 75% to 90% by weight of a thermoplastic material that contains natural potato starch and other biologically sourced polymers.

C. In certain embodiments, for example, the core compostable material is home compostable. In certain embodiments, for example, the core compostable material is home compostable according to AS5810. In certain embodiments, for example, the core compostable material is home compostable according to EN13432 Modified. In certain embodiments, for example, the core compostable material is home compostable according to French Standard NFT 51-800.

D. In certain embodiments, for example, the core layer further comprises a coloring additive. In certain embodiments, for example, the core layer comprises up to 20% by weight of the coloring additive, for example from 2.5% up to 17.5% or between 5% and 15% or between 3% and 12% by weight of the color additive. In certain embodiments, for example, the core layer comprises between 7.5% and 12.5% by weight of the coloring additive. In certain embodiments, for example, the core layer comprises up to 14% by weight of the coloring additive, for example from 6% up to 12% or between 9% and 11% of the color additive. In certain embodiments, for example, the core layer will have color additive in order to achieve an opacity of between 65% to 85%, such as 70% to 80%, or 73% to 77% opacity. In certain embodiments, for example, the coloring additive may comprise titanium dioxide and/or calcium carbonate or combination and/or mixtures thereof. In certain embodiments, for example, the core layer may comprise fillers including kaolin, ground calcium carbonate, precipitated calcium carbonate, talc and/or carbon black and/or mixtures thereof. In certain embodiments, for example, the core layer comprises up to 18% by weight of color additive or color additive plus filler, for example between 1% and 18%, between 2% and 14%, between 3% to 13%, between 4% to 12%, between 5% to 11%, between 6% to 10%, or between 7% to 9% of color additive or color additive plus filler.

In certain embodiments, for example, the core layer comprises up to 15% by weight of titanium dioxide, for example between 1% and 15%, between 2% and 14%, between 3% to 13%, between 4% to 12%, between 5% to 11%, between 6% to 10%, or between 7% to 9% of titanium dioxide. In certain embodiments, for example, the core layer will have titanium dioxide in order to achieve an opacity of between 65% to 85%, such as 70% to 80%, or 73% to 77% opacity.

E. In certain embodiments, for example, the core layer has an optical opacity of between 50% and 95%. In certain embodiments, for example, the core layer's optical opacity is between 60% and 90%, or between 65% and 85%, or between 70% and 80%. In certain embodiments, for example, the core layer's optical opacity is adjusted via the coloring additive. In certain embodiments, for example, the core layer comprises an amount of the coloring additive such that the core layer's optical opacity is between 60% and 90%, or between 65% and 85%, or between 70% and 80%.

F. In certain embodiments, for example, the core layer further comprises an anti-blocking agent. In certain embodiments, for example, the core layer comprises up to 10% by weight of the anti-blocking agent, for example from 0.005% up to 10%, between 0.01% to 10%, between 0.01% to 5%, between 0.02% to 4%, between 0.05% to 3%, between 0.1% to 2%, between 0.1% to 1.5%, between 0.5% to 2%, or between 0.5% to 1.5% of the anti-blocking agent. In certain embodiments, for example, the core layer comprises up to 5%, 4.5%, 4%, 3.5%, 3%, 2.5%, or 2% by weight of the anti-blocking agent. In certain embodiments, for example, the core layer comprises less than 3% by weight of the anti-blocking agent. In certain embodiments, for example, the anti-blocking agent is selected from a group consisting of silica, diatomaceous earth, and mixture thereof. In certain embodiments, for example, the anti-blocking agent is silica.

G. In certain embodiments, for example, the first skin layer is positioned proximate to at least a portion of the top surface of the core layer. In certain embodiments, for example, the first skin layer is positioned directly adjacent to at least a portion of the top surface of the core layer.

H. In certain embodiments, for example, first skin layer has a thickness less than a thickness of the core layer. In certain embodiments, for example, the first skin layer has a thickness that is 5 to 30% of the facestock's thickness.

I. In certain embodiments, for example, the first skin layer comprises a first compostable material. In certain embodiments, for example, the first compostable material is the same as the core compostable material. In certain embodiments, for example, the first compostable material is substantially the same as the core compostable material. In certain embodiments, for example, the first compostable material is different from the core compostable material. In certain embodiments for example, the first compostable material is selected from a group consisting of polybutylene adipate terephthalate (PBAT), polybutylene succinate (PBS), polybutylene succinate adipate (PBSA), polylactic acid (PLA), polyhydroxyalkanoate (PHA), polycaprolactone (PCL), thermoplastic material that contains natural potato starch and other biologically sourced polymers, and mixture thereof. In certain embodiments, for example, the first compostable material comprises from 1% to 99%, or 1% to 25% or 10% to 45%, or 15% to 35%, or 20% to 70% by weight of polybutylene adipate terephthalate (PBAT). In certain embodiments, for example, the first compostable material comprises from 1% to 99%, or 1% to 25% or 10% to 45%, or 15% to 35%, or 20% to 70% by weight of polybutylene succinate (PBS). In certain embodiments, for example, the first compostable material comprises from 1% to 99%, or 1% to 25% or 10% to 45%, or 15% to 35%, or 20% to 70% by weight of polybutylene succinate adipate (PBSA). In certain embodiments, for example, the core compostable material comprises from 25% to 99% by weight of polybutylene succinate adipate (PBSA). In certain embodiments, for example, the first compostable material comprises from 1% to 99%, or 1% to 25% or 10% to 45%, or 15% to 35%, or 20% to 70% by weight of polylactic acid (PLA). In certain embodiments, for example, the first compostable material comprises from 1% to 99%, or 1% to 25% or 10% to 45%, or 15% to 35%, or 20% to 70% by weight of a mixture of polybutylene adipate terephthalate (PBAT) and polylactic acid (PLA). In certain embodiments, for example, the core compostable material comprises from 1% to 99%, or 1% to 25% or 10% to 45%, or 15% to 35%, or 20% to 70% by weight of a mixture of polybutylene adipate terephthalate (PBAT) and polylactic acid (PLA). In certain embodiments, for example, the core compostable material comprises from 1% to 99%, or 1% to 25% or 10% to 45%, or 15% to 35%, or 20% to 70% by weight of a thermoplastic material that contains natural potato starch and other biologically sourced polymers.

J. In certain embodiments, for example, the first compostable material is home compostable. In certain embodiments, for example, the first compostable material is home compostable according to AS5810. In certain embodiments, for example, the first compostable material is home compostable according to EN13432 Modified. In certain embodiments, for example, the first compostable material is home compostable according to French Standard NFT 51-800.

K. In certain embodiments, for example, the first skin layer further comprises a coloring additive. In certain embodiments, for example, the first skin layer comprises up to 20% by weight of the coloring additive, for example from 2.5% up to 17.5% or between 5% to 15% of the color additive. In certain embodiments, for example, the first skin layer comprises between 7.5% to 12.5% by weight of the coloring additive. In certain embodiments, for example, the first skin layer comprises up to 10% by weight of the coloring additive, for example from 2% up to 8% or between 4% to 7% of the color additive. In certain embodiments, for example, the first skin layer comprises between 5% to 7% by weight of the coloring additive. In certain embodiments, for example, the first skin layer will have color additive in order to achieve an opacity of between 65% to 85%, such as 70% to 80%, or 73% to 77% opacity. In certain embodiments, for example, the coloring additive is titanium dioxide. In certain embodiments, for example, the first skin layer will have titanium dioxide in order to achieve an opacity of between 65% to 85%, such as 70% to 80%, or 73% to 77% opacity. In certain embodiments, for example, the coloring additive is calcium carbonate. In certain embodiments, for example, the first skin layer will have calcium carbonate in order to achieve an opacity of between 65% to 85%, such as 70% to 80%, or 73% to 77% opacity. In certain embodiments, for example, the first skin layer comprises up to 15% by weight of titanium dioxide, for example between 1% and 15%, between 2% and 14%, between 3% to 13%, between 4% to 12%, between 5% to 11%, between 6% to 10%, or between 7% to 9% of titanium dioxide.

L. In certain embodiments, for example, the first skin layer has an optical opacity of between 50% and 95%. In certain embodiments, for example, the first skin layer's optical opacity is between 60% and 90%, or between 65% and 85%, or between 70% and 80%. In certain embodiments, for example, the first skin layer's optical opacity is adjusted via the coloring additive. In certain embodiments, for example, the first skin layer comprises an amount of the coloring additive such that the first skin layer's optical opacity is between 60% and 90%, or between 65% and 85%, or between 70% and 80%.

M. In certain embodiments, for example, the first skin layer further comprises an anti-blocking agent. In certain embodiments, for example, the first skin layer comprises up to 10% by weight of the anti-blocking agent, for example from 0.005% up to 10%, between 0.01% to 10%, between 0.01% to 5%, between 0.02% to 4%, between 0.05% to 3%, between 0.1% to 2%, between 0.1% to 1.5%, between 0.5% to 2%, or between 0.5% to 1.5% of the anti-blocking agent. In certain embodiments, for example, the first skin layer comprises up to 5%, 4.5%, 4%, 3.5%, 3%, 2.5%, or 2% by weight of the anti-blocking agent. In certain embodiments, for example, the first skin layer comprises less than 3% by weight of the anti-blocking agent. In certain embodiments, for example, the anti-blocking agent is selected from a group consisting of silica, diatomaceous earth, and mixture thereof. In certain embodiments, for example, the anti-blocking agent is silica.

N. In certain embodiments, for example, the facestock has a thickness of 20 microns to 60 microns. In certain embodiments, for example, the thickness of the facestock is between 20 microns and 40 microns or between 24 microns and 32 microns. In certain embodiments, for example, the thickness of the facestock is determined according to ASTM D6988.

O. In certain embodiments, for example, the facestock consists of at least 75% by weight of one or more, for example between 80% and 99% by weight or between 90% and 99% by weight of materials whose glass transition temperature is 25° C. or less. In certain embodiments, for example, the facestock consists of at least 85% by weight of one or more materials whose glass transition temperature is 25° C. or less. In certain embodiments, for example, the glass transition temperature of the one or more materials is determined according to ASTM D7426.

P. In certain embodiments, for example, the facestock has a tensile strength in a machine direction of between 20 to 45 MPa, or between 25 and 35 MPa, or between 28 and 32 MPa. In certain embodiments, for example, the facestock has a tensile strength in a machine direction of about 30 MPa. In certain embodiments, for example, the facestock has a tensile modulus of elasticity in a machine direction of between 200 to 900 MPa or between 300 to 600 MPa, or between 350 and 500 MPa. In certain embodiments, for example, the facestock has a tensile modulus of elasticity in a machine direction of about 400 MPa. In certain embodiments, for example, the facestock has a percent elongation at break in a machine direction of between 110 to 800 or between 300 and 600, or between 400 and 550. In certain embodiments, for example, the facestock has a percent elongation at break of about 480. In certain embodiments, for example, the tensile strength of the facestock is determined according to ASTM D882. In certain embodiments, for example, the tensile modulus of elasticity of the facestock is determined according to ASTM D882. In certain embodiments, for example, the percent elongation at break of the facestock is determined according to ASTM D882.

Q. In certain embodiments, for example, the facestock is home compostable. In certain embodiments, for example, the facestock is home compostable according to AS5810. In certain embodiments, for example, the facestock is home compostable according to EN13432 Modified. In certain embodiments, for example, the facestock is home compostable according to French Standard NFT 51-800.

Certain embodiments may provide, for example, a facestock of a label comprising: i) a core layer; ii) a first skin layer; and iii) a second skin layer.

A. In certain embodiments, for example, the second skin layer is positioned proximate to at least a portion of the bottom surface of the core layer. In certain embodiments, for example, the second skin layer is positioned directly adjacent to at least a portion of the bottom.

B. In certain embodiments, for example, the second skin layer has a thickness that is the same as the first skin layer's thickness. In certain embodiments, for example, the second skin layer have a thickness that is different from the first skin layer's thickness. In certain embodiments, for example, the second skin layer has a thickness less than a thickness of the core layer. In certain embodiments, for example, the second skin layer has a thickness that is 3% to 30% or 5% to 20%, or 8% to 15% of the facestock's thickness.

C. In certain embodiments, for example, the second skin layer comprises a second compostable material. In certain embodiments, for example, the second compostable material is the same as the first compostable material. In certain embodiments, for example, the second compostable material is different from the first compostable material. In certain embodiments for example, the second compostable material is selected from a group consisting of polybutylene adipate terephthalate (PBAT), polybutylene succinate (PBS), polybutylene succinate adipate (PBSA), polylactic acid (PLA), polyhydroxyalkanoate (PHA), polycaprolactone (PCL), thermoplastic material that contains natural potato starch and other biologically sourced polymers, and mixture thereof. In certain embodiments, for example, the second compostable material comprises from 1% to 99%, or 1% to 25% or 10% to 45%, or 15% to 35%, or 20% to 70% by weight of polybutylene adipate terephthalate (PBAT). In certain embodiments, for example, the second compostable material comprises from 1% to 99%, or 1% to 25% or 10% to 45%, or 15% to 35%, or 20% to 70% by weight of polybutylene succinate (PBS). In certain embodiments, for example, the second compostable material comprises from 1% to 25% by weight of polybutylene succinate adipate (PBSA). In certain embodiments, for example, the second compostable material comprises from 1% to 99%, or 1% to 25% or 10% to 45%, or 15% to 35%, or 20% to 70% by weight of polybutylene succinate adipate (PBSA). In certain embodiments, for example, the second compostable material comprises from 1% to 99%, or 1% to 25% or 10% to 45%, or 15% to 35%, or 20% to 70% by weight of polylactic acid (PLA). In certain embodiments, for example, the second compostable material comprises from 1% to 99%, or 1% to 25% or 10% to 45%, or 15% to 35%, or 20% to 70% by weight of a mixture of polybutylene adipate terephthalate (PBAT) and polylactic acid (PLA). In certain embodiments, for example, the second compostable material comprises from 1% to 99%, or 1% to 25% or 10% to 45%, or 15% to 35%, or 20% to 70% by weight of a mixture of polybutylene adipate terephthalate (PBAT) and polylactic acid (PLA). In certain embodiments, for example, the second compostable material comprises from 1% to 99%, or 1% to 25% or 10% to 45%, or 15% to 35%, or 20% to 70% by weight of a thermoplastic material that contains natural potato starch and other biologically sourced polymers.

D. In certain embodiments, for example, the second compostable material is home compostable. In certain embodiments, for example, the second compostable material is home compostable according to AS5810. In certain embodiments, for example, the second compostable material is home compostable according to EN13432 Modified. In certain embodiments, for example, the second compostable material is home compostable according to French Standard NFT 51-800.

E. In certain embodiments, for example, the second skin layer further comprises a coloring additive. In certain embodiments, for example, the second skin layer comprises up to 20% by weight of the coloring additive, for example from 2.5% up to 17.5% or between 5% to 15% of the color additive. In certain embodiments, for example, the second skin layer comprises between 7.5% to 12.5% by weight of the coloring additive. In certain embodiments, for example, the second skin layer comprises up to 10% by weight of the coloring additive, for example from 2% up to 8% or between 4% to 7% of the color additive. In certain embodiments, for example, the second skin layer comprises between 5% to 7% by weight of the coloring additive. In certain embodiments, for example, the coloring additive is titanium dioxide. In certain embodiments, for example, the coloring additive is calcium carbonate. In certain embodiments, for example, the second skin layer will have color additive in order to achieve an opacity of between 65% to 85%, such as 70% to 80%, or 73% to 77% opacity. In certain embodiments, for example, the second skin layer comprises up to 15% by weight of titanium dioxide, for example between 1% and 15%, between 2% and 14%, between 3% to 13%, between 4% to 12%, between 5% to 11%, between 6% to 10%, or between 7% to 9% of titanium dioxide. In certain embodiments, for example, the second skin layer will have titanium dioxide in order to achieve an opacity of between 65% to 85%, such as 70% to 80%, or 73% to 77% opacity.

F. In certain embodiments, for example, the second skin layer has an optical opacity of between 50% and 95%. In certain embodiments, for example, the second skin layer's optical opacity is between 60% and 90%, or between 65% and 85%, or between 70% and 80%. In certain embodiments, for example, the second skin layer's optical opacity is adjusted via the coloring additive. In certain embodiments, for example, the second skin layer comprises an amount of the coloring additive such that the second skin layer's optical opacity is between 60% and 90%, or between 65% and 85%, or between 70% and 80%.

G. In certain embodiments, for example, the second skin layer further comprises an anti-blocking agent. In certain embodiments, for example, the second skin layer comprises up to 10% by weight of the anti-blocking agent, for example from 0.005% up to 10%, between 0.01% to 10%, between 0.01% to 5%, between 0.02% to 4%, between 0.05% to 3%, between 0.1% to 2%, between 0.1% to 1.5%, between 0.5% to 2%, or between 0.5% to 1.5% of the anti-blocking agent. In certain embodiments, for example, the second skin layer comprises up to 5%, 4.5%, 4%, 3.5%, 3%, 2.5%, or 2% by weight of the anti-blocking agent. In certain embodiments, for example, the second skin layer comprises less than 3% by weight of the anti-blocking agent. In certain embodiments, for example, the anti-blocking agent is selected from a group consisting of silica, diatomaceous earth, and mixture thereof. In certain embodiments, for example, the anti-blocking agent is silica.

Certain embodiments may provide, for example, a label comprising: i) a core layer; ii) a first skin layer; and iii) an adhesive layer.

A. In certain embodiments, for example, the label further comprises a second skin layer.

B. In certain embodiments, for example, the adhesive layer is positioned proximate to at least a portion of the bottom surface of the core layer. In certain embodiments, for example, the adhesive layer is positioned directly adjacent to at least a portion of the bottom surface of the core layer. In certain embodiments, for example, the adhesive layer is positioned proximate to at least a portion of second skin layer. In certain embodiments, for example, the adhesive layer is positioned directly adjacent to at least a portion of the second skin layer.

C. In certain embodiments, for example, the adhesive layer comprises an adhesive material. In certain embodiments, for example, the adhesive material comprises a discontinuous phase dispersed throughout an aqueous continuous phase. In certain embodiments, for example, the discontinuous phase comprises a plurality of particulates of a bio-based prepolymer. In certain embodiments, for example, the bio-based prepolymer is an epoxidized vegetable oil. In certain embodiments, for example, the epoxidized vegetable oil is epoxidized soybean oil.

D. In certain embodiments, for example, the adhesive material comprises a catalyst. In certain embodiments, for example, the catalyst is a water-soluble or a water stable catalyst. In certain embodiments, for example, the catalyst is a resides at least predominantly within the aqueous-based continuous phase. In certain embodiments, for example, the catalyst comprises one or more of an organic titanate catalyst, a zirconate catalyst, or combinations thereof. In certain embodiments, for example, the catalyst is a triethanolamine titanium complex.

E. In certain embodiments, for example, the label has a thickness of 20 microns to 60 microns. In certain embodiments, for example, the thickness of the label is between 20 microns and 40 microns or between 24 microns and 32 microns. In certain embodiments, for example, the thickness of the label is determined according to ASTM D6988.

F. In certain embodiments, for example, the label consists of at least 75% by weight of one or more, for example between 80% and 99% by weight or between 90% and 99% by weight of materials whose glass transition temperature is 25° C. or less. In certain embodiments, for example, the label consists of at least 85% by weight of one or more materials whose glass transition temperature is 25° C. or less. In certain embodiments, for example, the glass transition temperature of the one or more materials is determined according to ASTM D7426.

G. In certain embodiments, for example, the label has a tensile strength in a machine direction of between 20 to 45 MPa, or between 25 and 35 MPa, or between 28 and 32 MPa. In certain embodiments, for example, the label has a tensile strength in a machine direction of about 30 MPa. In certain embodiments, for example, the label has a tensile modulus of elasticity in a machine direction of between 200 to 900 MPa or between 300 to 600 MPa, or between 350 and 500 MPa. In certain embodiments, for example, the label has a tensile modulus of elasticity in a machine direction of about 400 MPa. In certain embodiments, for example, the label has a percent elongation at break in a machine direction of between 110 to 800 or between 300 and 600, or between 400 and 550. In certain embodiments, for example, the label has a percent elongation at break of about 480. In certain embodiments, for example, the tensile strength of the label is determined according to ASTM D882. In certain embodiments, for example, the tensile modulus of elasticity of the label is determined according to ASTM D882. In certain embodiments, for example, the percent elongation at break of the label is determined according to ASTM D882.

H. In certain embodiments, for example, the label is home compostable. In certain embodiments, for example, the label is home compostable according to AS5810. In certain embodiments, for example, the label is home compostable according to EN13432 Modified. In certain embodiments, for example, the label is home compostable according to French Standard NFT 51-800.

Certain embodiments may provide, for example, a label comprising: i) a core layer; ii) a first skin layer; iii) a second skin layer; iv) an adhesive layer; and v) an releasable liner.

In certain embodiments, for example, the releasable liner is positioned directly adjacent to the adhesive layer.

Certain embodiments may provide, for example, a method for manufacturing a facestock of a label comprising co-extrude a multilayer film, said film comprises a core layer and a first skin layer.

In certain embodiments, for example, the multilayer film further comprises a second skin layer.

Certain embodiments may provide, for example, a method for manufacturing a label comprising i) co-extrude a multilayer film; and ii) apply a layer of an adhesive to at least a portion of a surface of the multilayer film.

In certain embodiments, for example, the method further comprises iii) cover the layer of the adhesive with a releasable liner.

Certain embodiments may provide, for example, a home compostable composition comprising 30% to 95% by weight of polybutylene succinate adipate (PBSA); 5% to 15% by weight of a coloring additive; and up to 5% by weight of an anti-blocking agent.

A. In certain embodiments, for example, the home compostable composition further comprises 5% to 60% by weight of a blend of polybutylene adipate terephthalate (PBAT) and polylactic acid (PLA). In certain embodiments, for example, the blend contains 25% or less by weight of polylactic acid (PLA). In certain embodiments, for example, the blend is Ecovio F2224.

B. In certain embodiments, for example, the home compostable composition contains less than 5% by weight of polylactic acid (PLA). In certain embodiments, for example, the home compostable composition contains between 5% and 25% by weight of polylactic acid (PLA).

C. In certain embodiments, for example, the coloring additive is a white coloring additive. In certain embodiments, for example, the coloring additive comprises titanium dioxide. In certain embodiments, for example, the coloring additive comprises calcium carbonate. In certain embodiments, for example, the coloring additive further comprises a biodegradable carrier resin.

D. In certain embodiments, for example, the anti-blocking agent comprises silicon dioxide. In certain embodiments, for example, the anti-blocking agent further comprises a biodegradable carrier resin.

In certain embodiments, for example, the home compostable facestock may be formed from a composition that comprises up to 10% by weight of an anti-oxidant, for example up to 5% by weight, up to 3% by weight, or up to 1% by weight of an anti-oxidant even though the resulting facestock may have a lesser amount or no anti-oxidant or no anti-oxidant residue.

In certain embodiments the home compostable facestock or composition may be formed from, for example, a combination of components comprising (the following pre-mixture percentage by weight) 75% to 90% by weight of a biodegradable polymer; 5% to 20% by weight of a coloring additive; up to 5% by weight of an anti-blocking agent; and up to 5% by weight of an anti-oxidation agent; wherein the biodegradable polymer is polybutylene succinate adipate (PBSA) or a thermoplastic material that contains natural potato starch and other biologically sourced polymers.

A. In certain embodiments, for example, the thermoplastic material is Biome Bioplast 300.

B. In certain embodiments, for example, the home compostable composition contains less than 35% by weight of polylactic acid (PLA), for example less than 30% by weight, less than 25% by weight, less than 20% by weight, less than 15% by weight, less than 10% by weight, or less than 5% by weight of polylactic acid (PLA).

C. In certain embodiments, for example, the coloring additive is a white coloring additive. In certain embodiments, for example, the coloring additive comprises titanium dioxide. In certain embodiments, for example, the coloring additive comprises calcium carbonate. In certain embodiments, for example, the coloring additive further comprises a biodegradable carrier resin.

D. In certain embodiments, for example, the anti-blocking agent comprises silicon dioxide. In certain embodiments, for example, the anti-blocking agent further comprises a biodegradable carrier resin.

E. In certain embodiments, for example, the anti-oxidation agent comprises a biodegradable carrier resin.

### BRIEF DESCRIPTION OF THE DRAWINGS

FIG. 1 illustrates a cross-sectional view of a particular home compostable facestock of a label comprising a core layer and a first skin layer according to certain embodiments.

FIG. 2 illustrates a cross-sectional view of a particular home compostable facestock of a label comprising a core layer, a first skin layer, and a second skin layer according to certain embodiments.

FIG. 3 illustrates a cross-sectional view of a particular home compostable label comprising a core layer, a first skin layer, and an adhesive layer according to certain embodiments.

FIG. 4 illustrates a cross-sectional view of a particular home compostable label comprising a core layer, a first skin layer, a second skin layer, an adhesive layer, and a releasable liner according to certain embodiments.

FIG. 5 illustrates a particular method of manufacturing a home compostable facestock of a label according to certain embodiments.

FIG. 6 illustrates a particular method of manufacturing a home compostable label according to certain embodiments.

FIG. 7 illustrates various label adhesion profiles of the home compostable labels according to certain embodiments.

### DEFINITIONS

The term “compostable” is used throughout this document. Compostable products by definition are biodegradable. However, compostable products must also break down, or become part of usable, soil-enhancing compost in a safe and timely manner in an appropriate composting facility or home compost pile.

As used herein, “certified compostable” when referring to a product means a product that has met a defined standard through testing for heavy metals, biodegradation, disintegration and eco-toxicity and been awarded certification by a third party certification agency.

As used herein, “biodegradable” refers to the chemical degradation of a material.

As used herein, “disintegration” refers to the physical degradation of a material.

As used herein, “biodegradation” means quantitatively the inherent characteristic of the material to be consumed by microorganisms and protects the environment by showing that the material will not accumulate in nature. Biodegradability is therefore linked to the chemical composition of a material and represents the % of solid organic carbon converted to gaseous carbon under the form of CO₂.

As used herein, “bio-based” refers to commercial or industrial products that are composed in whole, or in significant part, of biological products or renewable domestic agricultural materials or forestry materials.

As used herein, “degradable plastic” refers to a plastic designed to undergo a significant change in its chemical structure under specific environmental conditions.

As used herein , “biodegradable plastic” refers to a degradable plastic in which the degradation results from the action of naturally occurring micro-organisms such as bacteria, fungi, and algae.

As used herein, “compostable plastic” refers to a plastic that undergoes degradation by biological processes during composting to yield CO₂, water, inorganic compounds, and biomass at a rate consistent with other known, compostable materials and leaves no visually distinguishable or toxic residue.

### DETAILED DESCRIPTION OF THE INVENTION

The present invention now will be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms include plural referents unless the context clearly dictates otherwise.

The present invention includes home compostable facestocks and labels suitable for a variety labeling applications, such as labeling of packing and/or directly on produce, such as edible skin fruits or vegetables. In certain embodiments, the facestock is a single layer facestock. In certain embodiments, the facestock is a multi-layer facestock, such as 2-layer, 3-layer, 4-layer, or more, comprising a core layer, comprising a core compostable material, and at least one skin layer, also comprising a compostable material, such as a first compostable material, which may be the same or a different material than that of the core compostable layer. As used herein, the use of the terms “core layer,” “core compostable material,” “first skin layer,” “first compostable material,” “second skin layer,” and “second compostable material,” are utilized merely to provide clarity as to which layer or material is being discussed. In certain embodiments, for example, all facestock layers may comprise the same of different materials.

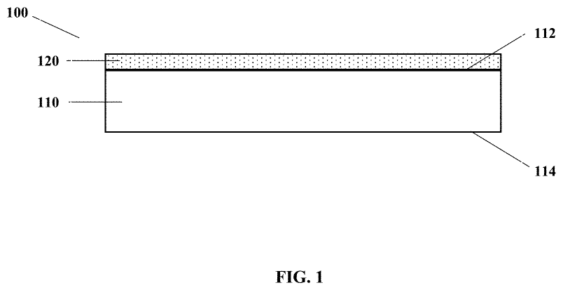

A. In certain embodiments, for example, a facestock according to the present invention is a 2-layer facestock. In FIG. 1 for example, the depicted facestock 100 comprises a core layer 110 and a first skin layer 120. The core layer 110 comprises a top surface 112 and a bottom surface 114. The first skin layer 120 is positioned directly adjacent to the top surface 112 of the core layer 110.

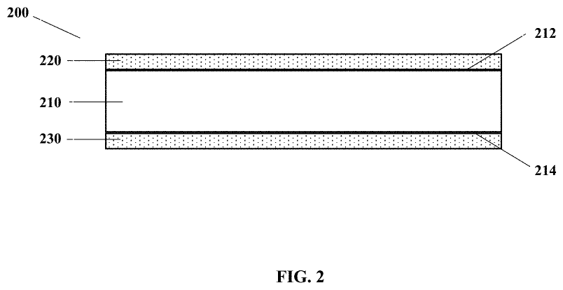

B. In certain embodiments, for example, a facestock according to the present invention is a 3-layer facestock. In FIG. 2 for example, the depicted facestock 200 comprises a core layer 210, a first skin layer 220, and a second skin layer 230. The core layer 210 comprises a top surface 212 and a bottom surface 214. The first skin layer 220 is positioned directly adjacent to the top surface 212 of the core layer 210; and the second skin layer 230 is positioned directly adjacent to the bottom surface 214 of the core layer 210.

In certain embodiments, for example, the core layer's thickness, may comprise from 30 to 99%, including each value and range therein, of a total aggregate thickness of all layers forming the facestock. In certain embodiments, for example, the core layer's thickness may comprise from 30 to 90%, from 30 to 80%, from 30 to 70%, from 30 to 60%, or from 30 to 50% of a total aggregate thickness of all layers forming the facestock. In certain embodiments, for example, the core layer's thickness may comprise from 40 to 99%, from 50 to 99%, from 60 to 99%, from 70 to 99%, from 80 to 99%, or from 90 to 99% of a total aggregate thickness of all layers forming the facestock. In certain embodiments, for example, the core layer's thickness may comprise from 30 to 40%, from 40 to 50%, from 50 to 60%, from 60 to 70%, from 70 to 80%, or from 80 to 90% of a total aggregate thickness of all layers forming the facestock. In certain embodiments, for example, the core layer's thickness may comprise from 35 to 95%, from 40 to 90%, from 45 to 85%, from 50 to 80%, from 55 to 75%, from 60 to 70%, of a total aggregate thickness of all layers forming the facestock. In certain embodiments, for example, the core layer's thickness may comprise 30, 35, 40, 45, 50, 55, 60, 65, 70, 75, 80, 85, 90, 95, or 99% a total aggregate thickness of all layers forming the facestock.

In certain embodiments, for example, the first skin layer's thickness and the second skin layer's thickness may each independently comprise from 0.5 to 30%, including each value and range therein, of a total aggregate thickness of all layers forming the facestock. In certain embodiments, for example, the respective thicknesses of the first skin layer and the second skin layer may be the same. In certain embodiments, for example, the respective thicknesses of the first skin layer and the second skin layer may be different. In certain embodiments, for example, the first skin layer thickness and said second skin layer thickness may each independently (i.e., the respective thicknesses may be the same or different) comprise from 0.5 to 25%, from 0.5 to 20%, from 0.5 to 15%, from 0.5 to 10%, or from 0.5 to 5% of a total aggregate thickness of all layers forming the facestock. In certain embodiments, for example, the first skin layer thickness and the second skin layer thickness may each independently comprise from about 1 to 30%, from 5 to 30%, from 10 to 30%, from 15 to 30%, from 20 to 30%, or from 25 to 30% of a total aggregate thickness of all layers forming the facestock. In certain embodiments, for example, the first skin layer thickness and the second skin layer thickness may each independently comprise from about 1 to 25%, from 5 to 20%, or from 10 to 25% of a total aggregate thickness of all layers forming the facestock. In certain embodiments, for example, the first skin layer thickness and the second skin layer thickness may each independently comprise from 5 to 10%, from 10 to 15%, from 15 to 20%, or from 20 to 25% of a total aggregate thickness of all layers forming the facestock. In certain embodiments, for example, the first skin layer thickness and the second skin layer thickness may each independently comprise 0.5, 1, 2, 5, 10, 15, 20, 25, or 30% of a total aggregate thickness of all layers forming the facestock.

In certain embodiments for example, the core compostable material, the first compostable material, and the second compostable material may each independently comprises one or more materials selected from a group consisting of polybutylene adipate terephthalate (PBAT), polybutylene succinate (PBS), polybutylene succinate adipate (PBSA), polylactic acid (PLA), and mixture thereof.

In certain embodiments for example, the core compostable material, the first compostable material, and the second compostable material may each independently comprises commercially-available compostable materials selected from a group consisting of Ecoflex (CAS 60961-73-1 or CAS 55231-08-8; 1,4-Benzenedicarboxylic acid, polymer with 1,4-butanediol and hexanedioic acid) from BASF, Ecoflex and PLA blends, Compostable 3002 (50-70% copolyester and PLA) from Cereplast, Ecovio (particular blends of PLA and Ecoflex, such as a 50/50 blend) from BASF; BioTuf 970 (PBAT-based material) from Heritage Plastics; MATER-BI (proprietary composition) from Novamont; Cardia Compostable B-F (compostable resin based on thermoplastic starch (TPS)) from Cardia Bioplastics, BioPBS from MCPP, Ecovio F2224 (blend of PABT and PLA), Biome Bioplast 300 (thermoplastic material that contains natural potato starch and other biologically sourced polymers), and mixture thereof.

In certain embodiments, for example, the core compostable material, the first compostable material, and the second compostable material may each independently comprises from 1% to 25% by weight, including each value and range therein, of polybutylene adipate terephthalate (PBAT). In certain embodiments, for example, the core compostable material, the first compostable material, and the second compostable material may each independently comprises from 2% to 25%, from 5% to 25%, from 10% to 25%, from 15% to 25%, or from 20% to 25% by weight of polybutylene adipate terephthalate (PBAT). In certain embodiments, for example, the core compostable material, the first compostable material, and the second compostable material may each independently comprises from 1% to 20%, from 1% to 15%, from 1% to 10%, or from 1% to 5% by weight of polybutylene adipate terephthalate (PBAT). In certain embodiments, for example, the core compostable material, the first compostable material, and the second compostable material may each independently comprise from 5% to 20%, or from 10% to 15% by weight of polybutylene adipate terephthalate (PBAT). In certain embodiments, for example, the core compostable material, the first compostable material, and the second compostable material may each independently comprise 1, 2, 5, 10, 15, 20, or 25% by weight of polybutylene adipate terephthalate (PBAT). In certain embodiments, for example, the polybutylene adipate terephthalate (PBAT) is Ecoflex F Blend C1200, which is commercially available from BASF.

In certain embodiments, for example, the core compostable material, the first compostable material, and the second compostable material may each independently comprises from 25% to 99% by weight, including each value and range therein, of polybutylene succinate (PBS). In certain embodiments, for example, the core compostable material, the first compostable material, and the second compostable material may each independently comprises from 25% to 99%, from 35% to 99%, from 45% to 99%, from 55% to 99%, from 65% to 99%, from 75% to 99%, from 85% to 99%, or from 95% to 99% by weight of polybutylene succinate (PBS). In certain embodiments, for example, the core compostable material, the first compostable material, and the second compostable material may each independently comprises from 25% to 90%, from 25% to 80%, from 25% to 70%, from 25% to 60%, from 25% to 50%, from 25% to 40%, or from 25% to 30% by weight of polybutylene succinate (PBS). In certain embodiments, for example, the core compostable material, the first compostable material, and the second compostable material may each independently comprises from 35% to 90%, from 45% to 80%, from 55% to 70%, or from 65% to 70% by weight of polybutylene succinate (PBS). In certain embodiments, for example, the core compostable material, the first compostable material, and the second compostable material may each independently comprises 25, 30, 35, 40, 45, 50, 55, 60, 65, 70, 75, 80, 85, 90, 95, 98, or 99% by weight of polybutylene succinate (PBS).

In certain embodiments, for example, the core compostable material, the first compostable material, and the second compostable material may each independently comprises from 1% to 25% by weight, including each value and range therein, of polybutylene succinate adipate (PBSA). In certain embodiments, for example, the core compostable material, the first compostable material, and the second compostable material may each independently comprises from 2% to 25%, from 5% to 25%, from 10% to 25%, from 15% to 25%, or from 20% to 25% by weight of polybutylene succinate adipate (PBSA). In certain embodiments, for example, the core compostable material, the first compostable material, and the second compostable material may each independently comprises from 1% to 20%, from 1% to 15%, from 1% to 10%, or from 1% to 5% by weight of polybutylene succinate adipate (PBSA). In certain embodiments, for example, the core compostable material, the first compostable material, and the second compostable material may each independently comprises from 5% to 20%, or from 10% to 15% by weight of polybutylene succinate adipate (PBSA). In certain embodiments, for example, the core compostable material, the first compostable material, and the second compostable material may each independently comprises 1, 2, 5, 10, 15, 20, or 25% by weight of polybutylene succinate adipate (PBSA). In certain embodiments, for example, the polybutylene succinate adipate (PBSA) is BioPBS FD92PM, which is commercially available from PTT-MCC Biochem.

In certain embodiments, for example, the core compostable material, the first compostable material, and the second compostable material may each independently comprises from 1% to 25% by weight, including each value and range therein, of polylactic acid (PLA). In certain embodiments, for example, the core compostable material, the first compostable material, and the second compostable material may each independently comprises from 2% to 25%, from 5% to 25%, from 10% to 25%, from 15% to 25%, or from 20% to 25% by weight of polylactic acid (PLA). In certain embodiments, for example, the core compostable material, the first compostable material, and the second compostable material may each independently comprises from 1% to 20%, from 1% to 15%, from 1% to 10%, or from 1% to 5% by weight of polylactic acid (PLA). In certain embodiments, for example, the core compostable material, the first compostable material, and the second compostable material may each independently comprises from 5% to 20%, or from 10% to 15% by weight of polylactic acid (PLA). In certain embodiments, for example, the core compostable material, the first compostable material, and the second compostable material may each independently comprise 1, 2, 5, 10, 15, 20, or 25% by weight of polylactic acid (PLA).

In certain embodiments, for example, the core compostable material, the first compostable material, and the second compostable material may each independently comprises from 5% to 95% by weight, including each value and range therein, of a mixture of polybutylene adipate terephthalate (PBAT) and polylactic acid (PLA). In certain embodiments, for example, the core compostable material, the first compostable material, and the second compostable material may each independently comprises from 15% to 95%, from 25% to 95%, from 35% to 95%, from 45% to 95%, from 55% to 95%, from 65% to 95%, from 75% to 95%, or from 85% to 95%, by weight of a mixture of polybutylene adipate terephthalate (PBAT) and polylactic acid (PLA). In certain embodiments, for example, the core compostable material, the first compostable material, and the second compostable material may each independently comprises from 5% to 85%, from 5% to 75%, from 5% to 65%, from 5% to 55%, from 5% to 45%, from 5% to 35%, from 5% to 25%, or from 5% to 15%, by weight of a mixture of polybutylene adipate terephthalate (PBAT) and polylactic acid (PLA). In certain embodiments, for example, the core compostable material, the first compostable material, and the second compostable material may each independently comprises from 15% to 85%, from 25% to 75%, from 35% to 65%, or from 45% to 55%, by weight of a mixture of polybutylene adipate terephthalate (PBAT) and polylactic acid (PLA). In certain embodiments, for example, the core compostable material, the first compostable material, and the second compostable material may each independently comprise 5, 15, 25, 35, 45, 55, 65, 75, 85, or 95% by weight of a mixture of polybutylene adipate terephthalate (PBAT) and polylactic acid (PLA). In certain embodiments, for example, mixture of polybutylene adipate terephthalate (PBAT) and polylactic acid (PLA) is Ecovio F2224, which is commercially available from BASF.

In certain embodiments, for example, the core layer, the first skin layer, and the second skin layer may each independently comprises a coloring additive. In certain embodiments, for example, the core layer, the first skin layer, and the second skin layer may each independently comprise up to 20, 15, 10, 5, 2, 1, 0.5, 0.2 or 0.1% by weight of the coloring additive. In certain embodiments, for example, the core layer, the first skin layer, and the second skin layer may each independently comprise 20, 15, 10, 5, 2, 1, 0.5, 0.2 or 0.1% by weight of the coloring additive. In certain embodiments, for example, the coloring additive is calcium carbonate. In certain embodiments, for example, the coloring additive is titanium dioxide. When used as a coloring additive, titanium dioxide may be referred to as titanium white, Pigment White 6 (PW6), or CI 77891. In certain embodiments, for example, the coloring additive comprises titanium dioxide and a carrier resin. In certain embodiments, for example, the coloring additive comprises titanium dioxide and a carrier of polybutylene adipate terephthalate (PBAT). In certain embodiments, for example, the coloring additive comprises titanium dioxide and a carrier of polybutylene succinate adipate (PBSA). In certain embodiments, for example, the coloring additive comprises titanium dioxide and a carrier of polybutylene succinate (PBS).

In certain embodiments, for example, the core layer, the first skin layer, and the second skin layer may each independently have an optical opacity of between 50% and 95%, between 60% and 90%, between 65% and 85%, or between 70% and 80%, including each value and range therein. In certain embodiments, for example, the core layer, the first skin layer, and the second skin layer may each independently have an optical opacity of 55%, 60%, 65%, 70%, 75%, 80%, 85%, or 90%. In certain embodiments, for example, the core layer, the first skin layer, and the second skin layer may each comprise an amount of the coloring additive such that the layer's optical opacity is between 50% and 95%, between 60% and 90%, between 65% and 85%, or between 70% and 80%, including each value and range therein. In certain embodiments, for example, the core layer, the first skin layer, and the second skin layer may each comprise an amount of the coloring additive such that the layer's optical opacity is 55%, 60%, 65%, 70%, 75%, 80%, 85%, or 90%.

In certain embodiments, for example, the core layer, the first skin layer, and the second skin layer may each independently comprises an anti-blocking agent. In certain embodiments, for example, the core layer, the first skin layer, and the second skin layer may each independently comprise up to 10, 5, 2, 1, 0.5, 0.2, or 0.1% by weight of the anti-blocking agent. In certain embodiments, for example, the core layer, the first skin layer, and the second skin layer may each independently comprise 10, 5, 2, 1, 0.5, 0.2, or 0.1% by weight of the anti-blocking agent. Any suitable anti-blocking agents may be used according to certain embodiments. Exemplary anti-blocking agents include mineral anti-blocking agents, such as silica and diatomaceous earth, or organic anti-blocking agents, such as polymethylmethacrylate (PMMA) beads. In certain embodiments, for example, anti-blocking agent further comprises a carrier resin. In certain embodiments, for example, anti-blocking agent further comprises a carrier of polybutylene adipate terephthalate (PBAT). In certain embodiments, for example, the anti-blocking agent further comprises a carrier of polybutylene succinate adipate (PBSA). In certain embodiments, for example, anti-blocking agent further comprises a carrier of polybutylene succinate (PBS).

In certain embodiments, for example, the facestock has a thickness of between 20 to 60 microns, including each value and range therein. In certain embodiments, for example, the facestock has a thickness of between 20 to 60 microns, between 25 to 60 microns, between 30 to 60 microns, between 35 to 60 microns, between 40 to 60 microns, between 45 to 60 microns, or between 50 to 60 microns. In certain embodiments, for example, the facestock has a thickness of between 20 to 50 microns, between 20 to 45 microns, between 20 to 40 microns, between 35 to 40 microns, between 20 to 30 microns, or between 20 to 25 microns. In certain embodiments, for example, the facestock has a thickness of between 25 to 45 microns, between 30 to 40 microns, or between 30 to 35 microns. In certain embodiments, for example, the facestock has a thickness of 20, 25, 30, 35, 36, 37, 38, 39, 40, 45, 50, or 55 microns.

In certain embodiments, for example, the facestock consists of a minimal amount of one or more materials whose glass transition temperature is not greater than 25° C. In certain embodiments, for example, the minimal amount is at least 75, 80, 85, 90, 95, or 99% by weight. In certain embodiments, for example, the facestock consists of 75, 80, 85, 90, 95, or 99% by weight of one or more materials whose glass transition temperature is not greater than 25° C.

In certain embodiments, for example, the facestock has a tensile strength in a machine direction of between 25 to 35 MPa, including each value and range therein. In certain embodiments, for example, the facestock has a tensile strength in a machine direction of between 27.5 to 35 MPa, between 30 to 35 MPa, or between 32.5 to 35 MPa. In certain embodiments, for example, the facestock has a tensile strength in a machine direction of between 25 to 32.5 MPa, between 25 to 30 MPa, or between 27.5 to 30 MPa. In certain embodiments, for example, the facestock has a tensile strength in a machine direction of between 25 to 35 MPa, between 25 to 32.5 MPa, between 25 to 30 MPa, between 27.5 to 30 MPa, or between 27.5 to 32.5 MPa. In certain embodiments, for example, the facestock has a tensile strength in a machine direction of 25, 27.5, 30, 32.5, or 35 MPa.

In certain embodiments, for example, the facestock may be tailored to exhibit a particular tensile modulus in a machine direction based on the intended final use of the film. For example, facestocks to be used as compostable labels for labeling, identifying, or tracking objects with curved surfaces, such as various fruit, may be formulated to exhibit a particular modulus in the machine direction. In certain embodiments, for example, the facestock has a tensile modulus of elasticity in a machine direction of between 200 to 900 MPa, including each value and range therein. In certain embodiments, for example, the facestock has a tensile modulus of elasticity in a machine direction of between 200 to 800 MPa, between 200 to 700 MPa, between 200 to 600 MPa, between 200 to 500 MPa, between 200 to 400 MPa, or between 200 to 300 MPa. In certain embodiments, for example, the facestock has a tensile modulus of elasticity in a machine direction of between 300 to 900 MPa, between 400 to 900 MPa, between 500 to 900 MPa, between 600 to 900 MPa, between 700 to 900 MPa, or between 800 to 900 MPa. In certain embodiments, for example, the facestock has a tensile modulus of elasticity in a machine direction of between 300 to 800 MPa, between 400 to 700 MPa, or between 500 to 600 MPa. In certain embodiments, for example, the facestock has a tensile modulus of elasticity in a machine direction of 200, 250, 300, 350, 400, 450, 500, 550, 600, 650, 700, 750, 800, 850, or 900 MPa. Additionally, in certain embodiments, for example, the facestock has a higher tensile modulus in a machine direction, and is better suited for incorporation into labels intended for adhering to more planar surfaces.

In certain embodiments, for example, the facestock has a percent elongation at break in a machine direction of between 110 to 600, including each value and range therein. In certain embodiments, for example, the facestock has a percent elongation at break of between 200 to 600, 300 to 600, 400 to 600, or 500 to 600. In certain embodiments, for example, the facestock has a percent elongation at break of between 110 to 500, 110 to 400, 110 to 300, or 110 to 200. In certain embodiments, for example, the facestock has a percent elongation at break of between 200 to 500, or 300 to 400. In certain embodiments, for example, the facestock has a percent elongation at break of 110, 150, 200, 250, 300, 350, 400, 450, 500, 550 or 600.

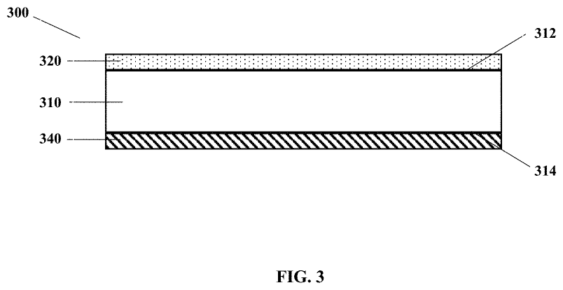

In certain embodiments, for example, a label according to the present invention is a 3-layer label. In FIG. 3 for example, the depicted label 300 comprises a core layer 310, a first skin layer 320, and an adhesive layer 340. The core layer 310 comprises a top surface 312 and a bottom surface 314. The first skin layer 320 is positioned directly adjacent to the top surface 312 of the core layer 310; and the adhesive layer 340 is positioned directly adjacent to the bottom surface 314 of the core layer 310.

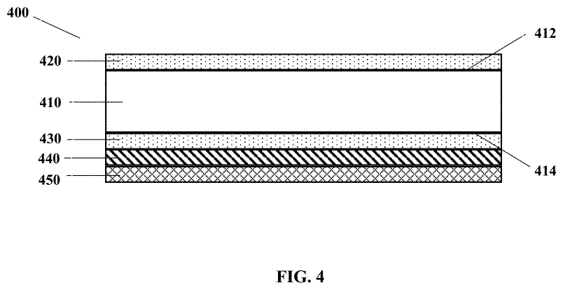

C. In certain embodiments, for example, a label according to the present invention is a 5-layer label. In FIG. 4 for example, the depicted label 400 comprises a core layer 410, a first skin layer 420, a second skin layer 430, an adhesive layer 440, and a releasable liner 450. The core layer 410 comprises a top surface 412 and a bottom surface 414. The first skin layer 420 is positioned directly adjacent to the top surface 412 of the core layer 410; the second skin layer 430 is positioned directly adjacent to the bottom surface 414 of the core layer 410; the adhesive layer 440 is positioned directly adjacent to the second skin layer 430; and the releasable liner 450 is positioned directly adjacent to the adhesive layer 440.

In certain embodiments, for example, the adhesive layer comprises an adhesive material, and the adhesive material comprises a discontinuous phase dispersed throughout an aqueous continuous phase. In certain embodiments, for example, the discontinuous phase comprises a plurality of particulates of a bio-based prepolymer. Any bio-based prepolymers may be utilized. In certain embodiments, for example, the bio-based prepolymer comprises may comprise one or more epoxidized fatty acids derived from plant oil, marine oil, other ester of unsaturated fatty acid, or combinations thereof. In certain embodiments, for example, the bio-based prepolymer may comprise epoxidized oleic acid, partially or fully epoxidized linoleic acid. In certain embodiments, for example, the bio-based prepolymer comprises epoxidized vegetable oil, such as epoxidized soybean oil.

In certain embodiments, for example, the adhesive material comprises a catalyst. In certain embodiments, for example, the catalyst is a water-soluble or a water stable catalyst. In certain embodiments, for example, the catalyst is an organic titanate catalyst, a zirconate catalyst, or combinations thereof. In certain embodiments, for example, the catalyst is a triethanolamine titanium complex. In certain embodiments, for example, the catalyst is TYZOR TE, which is commercially available from Dorf Ketal.

In certain embodiments, for example, the label comprises facestock (single or multi-layer), an adhesive (i.e., an adhesive layer) and/or inks (i.e., single or multi-layer of inks and/or coatings).

In certain embodiments, for example, the label has a thickness of between 20 to 60 microns, including each value and range therein. In certain embodiments, for example, the label has a thickness of between 20 to 60 microns, between 25 to 60 microns, between 30 to 60 microns, between 35 to 60 microns, between 40 to 60 microns, between 45 to 60 microns, or between 50 to 60 microns. In certain embodiments, for example, the label has a thickness of between 20 to 50 microns, between 20 to 45 microns, between 20 to 40 microns, between 20 to 35 microns, between 20 to 30 microns, or between 20 to 25 microns. In certain embodiments, for example, the label has a thickness of between 25 to 45 microns, between 30 to 40 microns, or between 30 to 35 microns. In certain embodiments, for example, the label has a thickness of 20, 25, 30, 35, 40, 45, 50, or 55 microns.

In certain embodiments, for example, the label consists of a minimal amount of one or more materials whose glass transition temperature is not greater than 25 ° C. In certain embodiments, for example, the minimal amount is at least 75, 80, 85, 90, 95, or 99% by weight. In certain embodiments, for example, the label consists of 75, 80, 85, 90, 95, or 99% by weight of one or more materials whose glass transition temperature is not greater than 25° C.

In certain embodiments, for example, the label has a tensile strength in a machine direction of between 25 to 35 MPa, including each value and range therein. In certain embodiments, for example, the label has a tensile strength in a machine direction of between 27.5 to 35 MPa, between 30 to 35 MPa, or between 32.5 to 35 MPa. In certain embodiments, for example, the label has a tensile strength in a machine direction of between 25 to 32.5 MPa, between 25 to 30 MPa, or between 27.5 to 30 MPa. In certain embodiments, for example, the label has a tensile strength in a machine direction of between 25 to 35 MPa, between 25 to 32.5 MPa, between 25 to 30 MPa, between 27.5 to 30 MPa, or between 27.5 to 32.5 MPa. In certain embodiments, for example, the label has a tensile strength in a machine direction of 25, 27.5, 30, 32.5, or 35 MPa.

In certain embodiments, for example, the label has a tensile modulus of elasticity in a machine direction of between 200 to 900 MPa, including each value and range therein. In certain embodiments, for example, the label has a tensile modulus of elasticity in a machine direction of between 200 to 800 MPa, between 200 to 700 MPa, between 200 to 600 MPa, between 200 to 500 MPa, between 200 to 400 MPa, or between 200 to 300 MPa. In certain embodiments, for example, the label has a tensile modulus of elasticity in a machine direction of between 300 to 900 MPa, between 400 to 900 MPa, between 500 to 900 MPa, between 600 to 900 MPa, between 700 to 900 MPa, or between 800 to 900 MPa. In certain embodiments, for example, the label has a tensile modulus of elasticity in a machine direction of between 300 to 800 MPa, between 400 to 700 MPa, or between 500 to 600 MPa. In certain embodiments, for example, the label has a tensile modulus of elasticity in a machine direction of 200, 250, 300, 350, 400, 450, 500, 550, 600, 650, 700, 750, 800, 850, or 900 MPa.

In certain embodiments, for example, the label has a percent elongation at break in a machine direction of between 110 to 600, including each value and range therein. In certain embodiments, for example, the label has a percent elongation at break of between 200 to 600, 300 to 600, 400 to 600, or 500 to 600. In certain embodiments, for example, the label has a percent elongation at break of between 110 to 500, 110 to 400, 110 to 300, or 110 to 200. In certain embodiments, for example, the label has a percent elongation at break of between 200 to 500, or 300 to 400. In certain embodiments, for example, the label has a percent elongation at break of 110, 150, 200, 250, 300, 350, 400, 450, 500, 550 or 600.

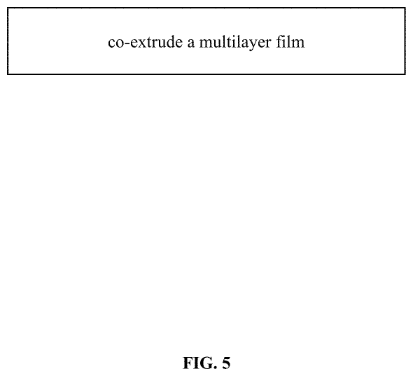

D. In certain embodiments, for example, the present invention relates to a method of manufacturing a facestock of a label. In FIG. 5, for example, the method comprises of co-extruding a multilayer film. In certain embodiments, for example, the multilayer film comprises a core layer, a first skin layer positioned directly adjacent a first surface of the core layer, and a second skin layer positioned directly adjacent a second surface of the core layer. In certain embodiments, the co-extruded multilayer film is home compostable. In certain embodiments, the manufactured facestock is home compostable. In certain embodiments, the label is home compostable.

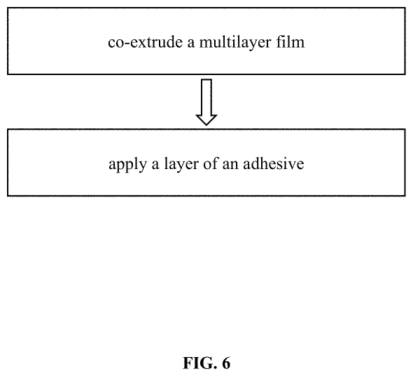

E. In certain embodiments, for example, the present invention relates to a method of manufacturing a label. In FIG. 6, for example, the method comprises of co-extruding a multilayer film, and then applying a layer of an adhesive. In certain embodiments, for example, the method further comprises covering the adhesive layer with a releasable liner. In certain embodiments, the multilayer film comprises a core layer, a first skin layer positioned directly adjacent a first surface of the core layer, and a second skin layer positioned directly adjacent a second surface of the core layer. In certain embodiments, the co-extruded multilayer film is home compostable. In certain embodiments, the manufactured label is home compostable.

In certain embodiments, for example, the present invention relates to a non-cellulosic, plasticizer free, home compostable food produce label suitable for high speed label machines comprising a 35 to 45 micron thick home-compostable multi-layer blown-extrusion film wherein the multi-layers may be two, three or more layers of co-extruded polymer compositions wherein the layers have a thickness ratio in a 2-layer co-extruded film of 5-50:95-50, such as 5-20:95-80 or 8-12:92-88 or 12-17:88-83 and a thickness ratio in the 3-layer co-extruded film of 5-35:90-30:5-35, such as 8-12:84-76:8-12 or 12-17:76-66:12-17 or 8-12:80-71:12-17, wherein all the layers may independently be a different thickness or the same thickness or the two outer layers may be the same thickness or the middle layer and one of the outer layers may be the same thickness and the other outer layer may be a different thickness.

In certain embodiments, for example, the present invention relates to a non-cellulosic, plasticizer free, home compostable food produce label suitable for high speed label machines comprising a 35 to 45 micron thick home-compostable, thermoplastic blown-extrusion film wherein the film maybe a monolayer film formed from a single polymer composition or a co-extruded multi-layer film formed from 2-, 3- or more polymer compositions forming 2-, 3-, or more layers of the multilayer film. The 3- or more layer multilayer film maybe formed from 2 polymer compositions layered in an alternating configuration with, for example the first and third layer of the multi-layer film being formed from the same polymer composition and the second layer of the multi-layer film being formed from a different polymer composition or in a four or more layer multi-layer film the alternating layers may be formed from the same polymer composition interleaved with layers formed from another polymer composition where the interleaved layers may formed from another polymer composition or multiple different polymer compositions. In certain embodiments, for example, the present invention relates to a non-cellulosic, plasticizer free, home compostable food produce label suitable for high speed label machines comprising a 35 to 45 micron thick home-compostable, thermoplastic blown-extrusion film wherein the film maybe a monolayer film with a polybutylene adipate terephthalate (PBAT) continuous phase with no more than 40 wt. % potato starch relative to the total weight of the outer layer, for example between 15-35 wt. % potato starch or 25-35 wt. % potato starch or 28-32 wt. % potato starch interspersed in a sub-continuous phase or in discontinuous manner or mixed portions of both, and no more than 20 wt. % polylactic acid (PLA) relative to the total weight of the film, for example between 3-15 wt. % PLA or 5-12 wt. % PLA or 6-9 wt. % PLA interspersed in a sub-continuous phase or in discontinuous manner or mixed portions of both; and optionally sufficient pigment for example titanium dioxide in an amount relative to the weight of the composition forming the film of less than 12 wt. % such as 3 wt. %-10 wt. % or 5 wt. %-8 wt. %, to achieve an opacity of the film of between 70% and 80%, such as 72%-77%.

In certain embodiments, for example, the present invention relates to a non-cellulosic, plasticizer free, home compostable food produce label suitable for high speed label machines comprising a 35 to 45 micron thick home-compostable multi-layer blown-extrusion film wherein an outer layer or both outer layers of the extruded film has a polybutylene adipate terephthalate (PBAT) continuous phase with no more than 40 wt. % potato starch relative to the total weight of the outer layer, for example between 15-35 wt. % potato starch or 25-35 wt. % potato starch or 28-32 wt. % potato starch interspersed in a sub-continuous phase or in discontinuous manner or mixed portions of both, and no more than 20 wt. % polylactic acid (PLA) relative to the total weight of the layer, for example between 3-15 wt. % PLA or 5-12 wt. % PLA or 6-9 wt. % PLA interspersed in a sub-continuous phase or in discontinuous manner or mixed portions of both; and optionally sufficient pigment, for example titanium dioxide in an amount relative to the weight of the composition forming the layer of less than 12 wt. % such as 3 wt. %-10 wt. % or 5 wt. %-8 wt. %, to achieve an opacity of the multilayer film of between 70% and 80%, such as 72%-77%.

In certain embodiments, for example, the present invention relates to a non-cellulosic, plasticizer free, home compostable food produce label suitable for high speed label machines comprising a 35 to 45 micron thick home-compostable multi-layer blown-extrusion film wherein an outer layer or both outer layers of the extruded film has a polybutylene adipate terephthalate (PBAT) continuous phase with no more than 40 wt. % potato starch relative to the total weight of the outer layer, for example between 15-35 wt. % potato starch or 25-35 wt. % potato starch or 28-32 wt. % potato starch interspersed in a sub-continuous phase or in discontinuous manner or mixed portions of both, and no more than 20 wt. % polylactic acid (PLA) relative to the total weight of the outer layer, for example between 3-15 wt. % PLA or 5-12 wt. % PLA or 6-9 wt. % PLA interspersed in a sub-continuous phase or in discontinuous manner or mixed portions of both; and optionally sufficient pigment, for example titanium dioxide in an amount relative to the weight of the composition forming the layer of less than 12 wt. % such as 3 wt. %-10 wt. % or 5 wt. %-8 wt. %, to achieve an opacity of the multilayer film of between 70% and 80%, such as 72%-77% and a middle layer with a bio-based polymer formed from the polymerization of succinic acid and 1,4-butanediol, for example polybutylene succinate (PBS), as the continuous phase and sufficient pigment, for example titanium dioxide in an amount relative to the weight of the composition forming the layer of less than 12 wt. % such as 3 wt. %-10 wt. % or 5 wt. %-8 wt. %, to achieve an opacity of the multilayer film of between 70% and 80%, such as 72%-77%.

In certain embodiments, for example, the present invention relates to a process of forming a non-cellulosic, plasticizer free, home compostable food produce label suitable for high speed label machines comprising a 35 to 45 micron thick home-compostable, thermoplastic blown-extrusion film wherein the film is formed from a polymer composition comprising greater than 60 wt. %, (on a pre-mixture basis) relative to the total composition forming the film, for example 65 wt. % to 90 wt. %, or 70 wt. % to 85 wt. % or 80 wt. % to 90 wt. %, of a polybutylene adipate terephthalate (PBAT) and potato starch mixture and no more than 20 wt. % polylactic acid (PLA), (on a pre-mixture basis) relative to the total weight of the composition forming the outer layer, for example between 3-15 wt. % PLA or 5-12 wt. % PLA or 6-9 wt. % PLA, and optionally sufficient pigment, for example titanium dioxide in an amount relative to the weight of the composition forming the layer of less than 12 wt. % such as 3 wt. %-10 wt. % or 5 wt. %-8 wt. %, to achieve an opacity of the film of between 70% and 80%, such as 72%-77%.

In certain embodiments, for example, the present invention relates to a process of forming a non-cellulosic, plasticizer free, home compostable food produce label suitable for high speed label machines comprising a 35 to 45 micron thick home-compostable multi-layer blown-extrusion film wherein an outer layer or both outer layers of the extruded film is formed from a polymer composition comprising greater than 60 wt. %, (on a pre-mixture basis) relative to the total composition forming the layer, for example 65 wt. % to 90 wt. %, or 70 wt. % to 85 wt. % or 80 wt. % to 90 wt. %, of a polybutylene adipate terephthalate (PBAT) and potato starch mixture and no more than 20 wt. % polylactic acid (PLA), (on a pre-mixture basis) relative to the total weight of the composition forming the layer, for example between 3-15 wt. % PLA or 5-12 wt. % PLA or 6-9 wt. % PLA, and optionally sufficient pigment, for example titanium dioxide in an amount relative to the weight of the composition forming the layer of less than 12 wt. % such as 3 wt. %-10 wt. % or 5 wt. %-8 wt. %, to achieve an opacity of the multilayer film of between 70% and 80%, such as 72%-77%.

In certain embodiments, for example, the present invention relates to a process of forming a non-cellulosic, plasticizer free, home compostable food produce label suitable for high speed label machines comprising a 35 to 45 micron thick home-compostable multi-layer blown-extrusion film wherein an outer layer or both outer layers of the extruded film is formed from a polymer composition comprising greater than 60 wt. %, (on a pre-mixture basis) relative to the total composition forming the layer, for example 65 wt. % to 90 wt. %, or 70 wt. % to 85 wt. % or 80 wt. % to 90 wt. %, of a polybutylene adipate terephthalate (PBAT) with potato starch mixture and no more than 20 wt. % polylactic acid (PLA), (on a pre-mixture basis) relative to the total weight of the composition forming the outer layer, for example between 3-15 wt. % PLA or 5-12 wt. % PLA or 6-9 wt. % PLA, and optionally sufficient pigment, for example titanium dioxide in an amount relative to the weight of the composition forming the layer of less than 12 wt. % such as 3 wt. %-10 wt. % or 5 wt. %-8 wt. %, to achieve an opacity of the multilayer film of between 70% and 80%, such as 72%-77% and a middle layer is formed from a polymer composition comprising greater than 60 wt. %, (on a pre-mixture basis) relative to the weight of the total composition forming the layer, for example 65 wt. % to 90 wt. %, or 70 wt. % to 85 wt. % or 80 wt. % to 90 wt. %, of a bio-based polymer formed from the polymerization of succinic acid and 1,4-butanediol, for example polybutylene succinate (PBS), and sufficient pigment, for example titanium dioxide in an amount relative to the weight of the composition forming the layer of less than 12 wt. % such as 3 wt. %-10 wt. % or 5 wt. %-8 wt. %, to achieve an opacity of the multilayer film of between 70% and 80%, such as 72%-77%.

F. In certain embodiments, for example, the present invention relates to a home compostable composition comprising (i) a first biodegradable polymer comprising natural potato starch, wherein the first biodegradable polymer has a glass transition temperature of less than 0° C.; (ii) a second biodegradable polymer having a glass transition temperature above 25° C.; and (iii) 5 to 10% by weight of titanium dioxide. In certain embodiments, the first biodegradable polymer is a thermoplastic material. In certain embodiments, the first biodegradable polymer is plasticizer-free. In certain embodiments, the first biodegradable polymer contains greater than 30 wt. % of renewable materials, relative to the total weight of the biodegradable polymer. In certain embodiments, the first biodegradable polymer contains a biobased carbon share of greater than 30 wt%, which is measured by ASTM D6866. In certain embodiments, the first biodegradable polymer further comprises polylactic acid (PLA). In certain embodiments, the polylactic acid (PLA) is biologically sourced.

G. In certain embodiments, for example, the present invention relates to a non-cellulosic home compostable food produce label comprising blown-extrusion film formed from any of the above home compostable compositions. In certain embodiments, wherein the film has a thickness of 35 to 45 micron. In certain embodiments, the food produce label is compliant with direct food contact US and EU regulations. In certain embodiments, the food produce label is suitable for use high speed label machine that operates at a rate of applying labels to the outer surface of produce at rate of at least 100 labels/minute, for example over 200 labels/minute or over 400 labels/minute or over 600 labels/minute, such as a Sinclair label machine featuring RM6 technology. In certain embodiments, the food produce label has a tensile strength in a machine direction of between 3800 and 4000 psi. In certain embodiments, the food produce label has a percent elongation at break in a machine direction of greater than 200. In certain embodiments, the food produce label has an optical opacity of greater than 70%.

H. In certain embodiments, for example, the present invention relates to a facestock of a label comprising (i) a core layer comprising a top surface, a bottom surface, and a core compostable material; (ii) a first skin layer and a seconds layer both comprising a skin compostable material, said first skin layer being positioned adjacent to at least a portion of the top surface of the core layer; and said second skin layer being positioned adjacent to at least a portion of the bottom surface of the core layer. In certain embodiments, the facestock is home compostable. In certain embodiments, the core layer has a thickness that is 60 to 80% of the facestock's thickness. In certain embodiments, the core compostable material comprises from 75% to 95% by weight of polybutylene succinate (PBS). In certain embodiments, the core layer further comprises a coloring additive. In certain embodiments, the core compostable material comprises up to 20% by weight of an coloring additive. In certain embodiments, the coloring additive is titanium dioxide. In certain embodiments, the core compostable material comprises up to 5% by weight of an anti-oxidation additive. In certain embodiments, the first and second skin layers both a thickness that is 10 to 20% of the facestock's thickness. In certain embodiments, the first and second skin layers have the same thickness. In certain embodiments, the skin compostable material is a home compostable composition according to any one of the preceding paragraphs. In certain embodiments, the thickness of the facestock is about 38 microns.

I. In certain embodiments, for example, the present invention relates to a non-cellulosic home compostable food produce label, suitable for high speed label machines, comprising 35-45 micron thick home-compostable blown-extrusion film formed from a blend of polymers comprising: (i) greater than 50 wt. % of a plasticizer-free thermoplastic material comprising a biologically-sourced carrier polymer and a thermoplastic starch having greater than 30 wt. %, relative to the total weight of the thermoplastic material, and optionally a slip agent; and (ii) a second polymer composition comprising a biologically-sourced carrier polymer and a “stiff” polymer having a glass transition temperature of greater than 20° C., wherein the “stiff” polymer is less than 10 wt. % of the blend of polymers forming the blown-extrusion film.

In certain embodiments, for example, the non-cellulosic home compostable food produce label may be compliant with direct food contact FDA and/or EU regulations.

In certain embodiments, for example, the non-cellulosic home compostable food produce label may be suitable for high speed label machines at greater than 100, 200, 400, 500 labels/minute, in particular 600-800 labels/minute.

In certain embodiments, for example, the home-compostable blown-extrusion film may be formed from a blend of polymers comprising greater than 50, 60, 70, 75, or 80 wt. % of the plasticizer-free thermoplastic material. In certain embodiments, for example, the biologically-sourced carrier polymer in the plasticizer-free thermoplastic material may be polybutylene adipate terephthalate (PBAT), polylactic acid (PLA), polybutylene succinate (PBS), or any mixture thereof. In certain embodiments, for example, the thermoplastic starch in in the plasticizer-free thermoplastic material may be natural potato starch.

In certain embodiments, for example, the biologically-sourced carrier polymer in the second polymer composition may be the same or different from the carrier polymer in the thermoplastic material. In certain embodiments, for example, the biologically-sourced carrier polymer in the second polymer composition may be polybutylene adipate terephthalate (PBAT), polylactic acid (PLA), polybutylene succinate (PBS), or any mixture thereof. In certain embodiments, for example, the “stiff” polymer may have a glass transition temperature of greater than 25, 30, 35, 40, 45, or 50° C. In certain embodiments, for example, the “stiff” polymer may be less than 8, 6, 5, or 3 wt. % of the blend of polymers forming the blown-extrusion film.

In certain embodiments, for example, the blown-extrusion film may have a total solid content of more than 95 or 98%. In certain embodiments, for example, the volatile solid content in the total solid content may be greater than 85 or 90%. In certain embodiments, for example, the ash content in the total solid content may be less than 15 or 10%. In certain embodiments, the total solid content of the film may contain less than 5 ppm of arsenic, less than 0.75 ppm of selenium, less than 0.5 ppm of mercury, less than 0.5 ppm of cadmium, less than 50 ppm of coper, less than 50 ppm of chromium, less than 1 ppm of molybdenum, less than 25 ppm of nickel, less than 50 ppm of lead, less than 150 ppm of zinc, and/or less than 100 ppm of fluorine.

J. In certain embodiments, for example, the present invention relates to a non- cellulosic home compostable food produce label, suitable for high speed label machines, comprising 35-45 micron thick home-compostable blown-extrusion film formed from a blend of polymers comprising: (i) greater than 50 wt. %, relative to the total weight of the blend of polymers, of a plasticizer-free thermoplastic material comprising: (a) greater than 50 wt. %, relative to the total weight of the thermoplastic material, of polybutylene adipate terephthalate (PBAT), and (b) between 25 wt. % to 40 wt. %, relative to the total weight of the thermoplastic material, of natural potato starch, and the thermoplastic material having greater than 30 wt. %, relative to the total weight of the thermoplastic material, of renewable raw materials and the biobased carbon share of the thermoplastic material exceeds 30%, wherein the thermoplastic material has a glass transition temperature of less than 0° C.; and (ii) between 5 wt. % and 50 wt. %, relative to the total weight of the blend of polymers, of a second polymer composition comprising (a) greater than 50 wt. %, relative to the total weight of the second polymer composition, of polybutylene adipate terephthalate (PBAT), and (b) between 5 wt. % and 50 wt. %, relative to the total weight of the second polymer composition, of a “stiff” polymer having a glass transition temperature greater than 20° C.

In certain embodiments, for example, the non-cellulosic home compostable food produce label may be compliant with direct food contact FDA and/or EU regulations.

In certain embodiments, for example, the non-cellulosic home compostable food produce label may be suitable for high speed label machines at greater than 100, 200, 400, 500 labels/minute.

In certain embodiments, for example, the biobased carbon share of the thermoplastic material may be measured according to ASTM D6866.

In certain embodiments, for example, the glass transition temperature of the thermoplastic material may be less than −10, −20, or −30° C.

In certain embodiments, for example, the second polymer composition may comprise between 10 and 50, between 20 and 50, between 35 and 50, or between 40 and 48 wt. %, relative to the total weight of the second polymer composition, of the “stiff” polymer. In certain embodiments, for example, the “stiff” polymer may have a glass transition temperature of greater than 25, 30, 35, 40, 45, or 50° C.

In certain embodiments, for example, the blown-extrusion film may have a total solid content of more than 95 or 98%. In certain embodiments, for example, the volatile solid content in the total solid content may be greater than 85 or 90%. In certain embodiments, for example, the ash content in the total solid content may be less than 15 or 10%. In certain embodiments, the total solid content of the film may contain less than 5 ppm of arsenic, less than 0.75 ppm of selenium, less than 0.5 ppm of mercury, less than 0.5 ppm of cadmium, less than 50 ppm of coper, less than 50 ppm of chromium, less than 1 ppm of molybdenum, less than 25 ppm of nickel, less than 50 ppm of lead, less than 150 ppm of zinc, and/or less than 100 ppm of fluorine.

K. In certain embodiments, for example, the present invention relates to a non-cellulosic home compostable food produce label suitable for high speed label machines comprising 35-45 micron thick home-compostable blown-extrusion film formed from a blend of polymers comprising: (i) greater than 50 wt. %, relative to the total weight of the blend of polymers, of a plasticizer-free thermoplastic material comprising: (a) greater than 50 wt. %, relative to the total weight of the thermoplastic material, of polybutylene adipate terephthalate (PBAT), and (b) between 25 wt. % to 40 wt. %, relative to the total weight of the thermoplastic material, of natural potato starch, and the thermoplastic material having greater than 30 wt. %, relative to the total weight of the thermoplastic material, of renewable raw materials and the biobased carbon share of the thermoplastic material exceeds 30%, wherein the thermoplastic material has a glass transition temperature of less than 0° C.; and (ii) between 5 wt. % and 50 wt. %, relative to the total weight of the blend of polymers, of a second polymer composition comprising (a) greater than 50 wt. %, relative to the total weight of the second polymer composition, of polybutylene adipate terephthalate (PBAT) and (b) between 5 wt. % and 50 wt. %, relative to the total weight of the further polymer, of polylactic acid (PLA).

In certain embodiments, for example, the non-cellulosic home compostable food produce label may be compliant with direct food contact FDA and/or EU regulations.

In certain embodiments, for example, the non-cellulosic home compostable food produce label may be suitable for high speed label machines at greater than 100, 200, 400, 500 labels/minute.

In certain embodiments, for example, the biobased carbon share of the thermoplastic material may be measured according to ASTM D6866.

In certain embodiments, for example, the second polymer composition may comprise between 10 and 50, between 20 and 50, between 35 and 50, or between 40 and 48 wt. % of polylactic acid (PLA), relative to the total weight of the second polymer composition.

In certain embodiments, for example, the blown-extrusion film may have a total solid content of more than 95 or 98%. In certain embodiments, for example, the volatile solid content in the total solid content may be greater than 85 or 90%. In certain embodiments, for example, the ash content in the total solid content may be less than 15 or 10%. In certain embodiments, the total solid content of the film may contain less than 5 ppm of arsenic, less than 0.75 ppm of selenium, less than 0.5 ppm of mercury, less than 0.5 ppm of cadmium, less than 50 ppm of coper, less than 50 ppm of chromium, less than 1 ppm of molybdenum, less than 25 ppm of nickel, less than 50 ppm of lead, less than 150 ppm of zinc, and/or less than 100 ppm of fluorine.

L. In certain embodiments, for example, the present invention relates to: a non-cellulosic home compostable food produce label, suitable for high speed label machines, comprising 35-45 micron thick home-compostable blown-extrusion film formed from a blend of polymers comprising: (i) greater than 50 wt. %, relative to the total weight of the blend of polymers, of a plasticizer-free thermoplastic biologically sourced polymer having a glass transition temperature of less than less than 0° C.; (ii) between 15 wt. % to 30 wt. %, relative to the total weight of the blend of polymers, of a thermoplastic starch, and (iii) less than 15 wt. %, relative to the total weight of the blend of polymers, of a “stiff” polymer having a glass transition temperature greater than 20° C.

In certain embodiments, for example, the non-cellulosic home compostable food produce label may be compliant with direct food contact FDA and/or EU regulations.

In certain embodiments, for example, the non-cellulosic home compostable food produce label may be suitable for high speed label machines at greater than 100, 200, 400, 500 labels/minute.

In certain embodiments, for example, the plasticizer-free thermoplastic biologically sourced polymer may have a glass transition temperature of less than less than −10, −20, −30° C. In certain embodiments, for example, the plasticizer-free thermoplastic biologically sourced polymer may be polybutylene adipate terephthalate (PBAT), polylactic acid (PLA), polybutylene succinate (PBS), or any mixture thereof.

In certain embodiments, for example, the thermoplastic starch may be the natural potato, corn, pea, tapioca, or rice starch.

In certain embodiments, for example, the blend of polymers may comprise between 3 and 12, between 4 and 10, or between 5 and 8 wt. % of the “stiff polymer.” In some embodiments, for example, the “stiff” polymer may have a glass transition temperature greater than 25, 30, 35, 40, 45, or 50° C.

In certain embodiments, for example, the blown-extrusion film may have a total solid content of more than 95 or 98%. In certain embodiments, for example, the volatile solid content in the total solid content may be greater than 85 or 90%. In certain embodiments, for example, the ash content in the total solid content may be less than 15 or 10%. In certain embodiments, the total solid content of the film may contain less than 5 ppm of arsenic, less than 0.75 ppm of selenium, less than 0.5 ppm of mercury, less than 0.5 ppm of cadmium, less than 50 ppm of coper, less than 50 ppm of chromium, less than 1 ppm of molybdenum, less than 25 ppm of nickel, less than 50 ppm of lead, less than 150 ppm of zinc, and/or less than 100 ppm of fluorine.

### EXAMPLES

Certain embodiments are illustrated by the following non-limiting examples. The discussion below is offered to illustrate certain aspects of the present disclosure and is not intended to limit the scope of the claims. Changes can be made to the embodiments in light of the detailed description below. Although specific embodiments have been described herein for purposes of illustration, various modifications for carrying out the disclosure that are obvious to persons of skill in the art are intended to be within the scope of the claims.

### Prophetic Example 1—Facestock Formulation

As shown in Table 1, a facestock comprising three layers will be formed by a co-extruding process.

TABLE 1

| | % of total | Wt. | | Material | |
|---|---|---|---|---|---|
| | thickness | % | Component | Description | Supplier |
| Layer 1: | 15 | | | | |
| Component 1 | | 1 | Anti-Blocking | Home Compostable AB | Colortech |
| | | | Agent | MB (100LX5149) | |
| Component 2 | | 10 | Coloring Additive | Biopolymer White MB | Colortech |
| | | | | (11004-489) | |
| Component 3 | | 84 | Primary Resin | BioPBS FD92PM | PTT |
| | | | | | MCC |
| | | | | | Biochem |
| Component 4 | | 5 | Secondary Resin | Ecovio F2224 | BASF |
| Layer 2: | 70 | | | | |
| Component 1 | | 10 | Coloring Additive | Biopolymer White MB | Colortech |
| | | | | (11004-489) | |
| Component 2 | | 85 | Primary Resin | BioPBS FD92PM | PTT |
| | | | | | MCC |
| | | | | | Biochem |
| Component 3 | | 5 | Secondary Resin | Ecovio F2224 | BASF |
| Layer 3: | 15 | | | | |

same as Layer 1
Table Notes:
BioPBS FD92PM comprises predominately PBSA; Ecovio F2224 is a blend of Ecoflex C1200 (predominately PBAT) with approximately 45 wt. % PLA; Biopolymer White MB (11004-489) is a 70 wt. % TiO₂ white masterbatch with a compostable carrier resin; and Home Compostable AB MB (100LX5149) is a 55 wt. % anti-block masterbatch with a compostable carrier resin;

After fabrication of the home compostable facestock described above, it will be subjected to a variety of tests as described below.

### Prophetic Example 2—Tests of Tensile Properties

The tensile properties of a facestock or label, including tensile strength, tensile modulus of elasticity, and percent elongation at break, are tested as follows.

A specimen of uniform cross-section is loaded in tension via means of a mechanical testing machine. Force and or extension are recorded during the test. Various techniques for specimen gripping and extension measurement are addressed. Depending on the elongation of the material and the desired properties to be gained from the testing, various combinations of grip separation and test speed are utilized. Properties such as stress, elongation and modulus can be calculated.

The test specimens shall consist of strips of uniform width and thickness at least 50 mm (2 in.) longer than the grip separation used. The nominal width of the specimens shall be not less than 5.0 mm (0.20 in.) or greater than 25.4 mm (1.0 in.). A width-thickness ratio of at least eight shall be used. Narrow specimens magnify effects of edge strains or flaws, or both.

The utmost care shall be exercised in cutting specimens to prevent nicks and tears that cause premature failures. Microscopical examination of specimens can be used to detect flaws due to sample or specimen preparation. The edges shall be parallel to within 5% of the width over the length of the specimen between the grips.

Test specimens shall be selected so that thickness is uniform to within 10% of the average thickness over the length of the specimen between the grips in the case of specimens 0.25 mm (0.010 in.) or less in thickness and to within 5% in the case of specimens greater than 0.25 mm (0.010 in.) in thickness but less than 1.00 mm (0.040 in.) in thickness.

If the material is suspected of being anisotropic, two sets of test specimens shall be prepared having their long axes respectively parallel with and normal to the suspected direction of anisotropy.

For tensile modulus of elasticity determinations, a specimen gage length of 250 mm (10 in.) shall be considered as standard. This length is used in order to minimize the effects of grip slippage on test results. When this length is not feasible, test sections as short as 100 mm (4 in.) can be used if it has been shown that results are not appreciably affected. However, the 250-mm (10-in.) gage length shall be used for referee purposes. The speed of testing of shorter specimens must be adjusted in order for the strain rate to be equivalent to that of the standard specimen.

Condition the test specimens at 23±2° C. (73.4±3.6° F.) and 50±10% relative humidity for not less than 40 h prior to test. Conduct the tests at 23±2° C. (73.4±3.6° F.) and 50±10% relative humidity.

The speed of testing is the rate of separation of the two members (or grips) of the testing machine when running idle (under no force). This rate of separation shall be maintained within 5% of the no-force value when running under full-capacity force.

The speed of testing shall be calculated from the required initial strain rate. For modulus of elasticity determination, the required initial strain rate is 0.1 mm/mm·min; for determinations of other properties, the required initial strain rate is 10.0 mm/mm·min when the percent elongate at break is greater than 100. The rate of grip separation shall be determined for the purpose of these test methods from the initial strain rate using equation A=BC, where A=rate of grip separation, mm (or in.)/min; B=initial distance between grips, mm (or in.); and C=initial strain rate, mm/mm·min (or in./in. min).

If modulus values are being determined, separate specimens shall be used whenever strain rates and specimen dimensions are not the same as those employed in the test for other tensile properties.

### Prophetic Example 3—Determination of Thickness

The thickness of a facestock or label may be determined using a variety of different instruments, including manually operated thickness gauge, automatically operated thickness gauge, manually operated thickness gauge with linear optical encoder, and automatically operated thickness gauge with digital display. Allow specimens to equilibrate at 23±2° C. (73.4±3.6° F.) and 50±10% before testing.

### Prophetic Example 4—Determination of Glass Transition Temperature

Each of the facestock's material components is assigned a glass transition temperatures (T_{g}) using differential scanning calorimetry. The glass transition temperature of several compostable resins are listed in Table 2.

TABLE 2

| Resin Type | Chemical Structure | Tg, ° C. | Trade Name | Supplier |
|---|---|---|---|---|
| PBAT | Polybutylene Adipate | −36 | Ecoflex | BASF |
| | Terephthalate | | | |
| PLA | Polylactic Acid | 60-65 | Ingeo | NatureWorks |
| PBS | Polybutylene Succinate | −33 | BioPBS | PTT MCC Biochem |
| PBSA | Polybutylene Succinate | −43 | BioPBS | PTT MCC Biochem |
| | Adipate | | | |
| PHA | Polyhydroxyalkanoate | 2-8 | Nodax | Danimer Scientific |
| PCL | Polycaprolactone | −60 | Tone | Union Carbide |

The testing method involves continuously monitoring the difference in heat flow, or temperature between, a reference material and a test material when they are heated or cooled at a controlled rate through the glass transition region of the test material and analyzing the resultant thermal curve to provide the glass transition temperature.

When preparing specimen in the form of powders or granules, avoid grinding if a preliminary thermal cycle is not performed. Grinding, microtoming, or similar techniques for size reduction often introduce thermal effects because of friction or orientation, or both, and thereby change the thermal history of the specimen.

When preparing specimen in the form of molded parts or pellets, cut the samples with a microtome, razor blade, paper punch, or cork borer (size No. 2 or 3) to appropriate size in thickness or diameter, and length that will approximate the desired mass in the subsequent procedure.

When preparing specimen in the form of films or sheets, for films thicker than 40 μm, they should be treated as described above for molded parts or pellets; for thinner films, cut slivers to fit in the specimen tubes or punch disks, if circular specimen pans are used.

### Prophetic Example 5—Determination of Adhesion Profile

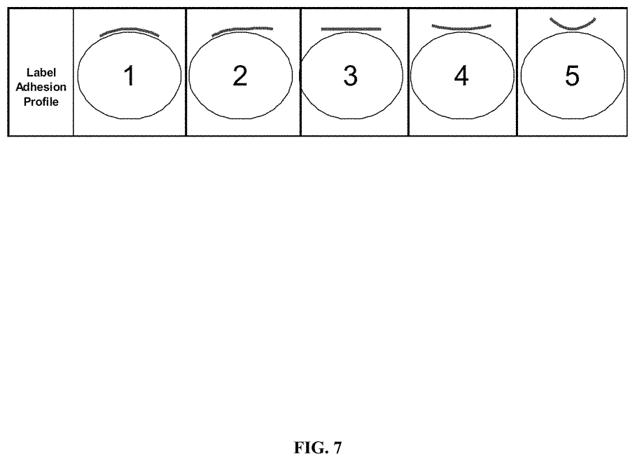

The adhesion profile of a label is determined with reference to FIG. 7. Label adhesion profile is evaluated at time of application and post shipping through the supply chain or simulated conditions and scored in accordance with the Adhesion Score Test.

### Example 6—Facestock Formulations HC1 to HC8

Tables 3A and 3B provide the list of components (in pre-mixture weight percentages) for eight facestock formulations:

TABLE 3A

| | Resin/ | | | | |
|---|---|---|---|---|---|
| Supplier | Additive ID | HC1 | HC2 | HC3 | HC4 |
| PTT-MCC Biochem | BioPBS FD92PM | 90.4 | 79.28 | 68.17 | 57.06 |
| | (wt. %) | | | | |
| BASF | Ecovio F2224 | — | 11.12 | 22.23 | 33.34 |
| | (wt. %) | | | | |
| Colortech | Biopolymer | 8.6 | 8.6 | 8.6 | 8.6 |
| | White MB | | | | |
| | (11004-489) | | | | |
| | (wt. %) | | | | |
| Colortech | Home Compostable | 1 | 1 | 1 | 1 |
| | AB MB | | | | |
| | (100LX5149) | | | | |
| | (wt. %) | | | | |
| | Thickness | 38 | 38 | 38 | 38 |
| | Target, | | | | |
| | micron | | | | |
| | Net PLA Content, | 0 | 5 | 10 | 15 |
| | (wt. %) | | | | |

TABLE 3B

| | Resin/ | | | | |
|---|---|---|---|---|---|
| Supplier | Additive ID | HC5 | HC6 | HC7 | HC8 |
| PTT-MCC Biochem | BioPBS FD92PM | 45.95 | 34.84 | 81 | — |
| | (wt. %) | | | | |
| Biome Bioplastics | Biome Bioplast 300 | — | — | — | 85 |
| | (wt. %) | | | | |
| BASF | Ecovio F2224 | 44.45 | 55.56 | — | — |
| | (wt. %) | | | | |
| Colortech | Biopolymer | 8.6 | 8.6 | — | — |
| | White MB | | | | |
| | (11004-489) | | | | |
| | (wt. %) | | | | |
| Colortech | Home Compostable | 1 | 1 | — | — |
| | AB MB | | | | |
| | (100LX5149) | | | | |
| | (wt. %) | | | | |
| Colortech | Home Compostable | — | — | 15 | 15 |
| | White | | | | |
| | (110LM7999) | | | | |
| | (wt. %) | | | | |
| PTT-MCC Biochem | BioPBS MB92AM(wt. %) | — | — | 2 | — |
| PTT-MCC Biochem | BioPBS MB92SM(wt. %) | — | — | 2 | — |
| | Thickness | 38 | 38 | 38 | 38 |
| | Target, | | | | |
| | micron | | | | |
| | Opacity | | | 75 | 75 |
| | Target, % | | | | |
| | Net PLA Content, | 20 | 25 | | |
| | (wt. %) | | | | |

Table Notes:
BioPBS FD92PM comprises predominately PBSA; Biome Bioplast 300 is a polymer composition comprising natural potato starch in a PBAT carrier; Ecovio F2224 is a blend of Ecoflex C1200 (predominately PBAT) with approximately 45 wt. % PLA; Biopolymer White MB (11004-489) is a 70 wt. % TiO₂ white masterbatch with a compostable carrier resin; Home Compostable AB MB (100LX5149) is a 55 wt. % anti-block masterbatch with a compostable carrier resin; Home Compostable White (110LM7999) is a 70 wt. % TiO₂ masterbatch with a compostable carrier resin; BioPBS MB92AM is an antioxidant masterbatch with a PBSA carrier resin; and BioPBS MB92SM is a slip & anti-block masterbatch with a PBSA carrier resin.

After fabrication, three samples HC1, HC3, and HC5 were subjected to a variety of tests and the results are described below.

### Example 7—Properties of Facestock Formulations

Table 4 shows the mechanical and physical properties of three facestock formulations HC1, HC3, and HC5:

TABLE 4

| Property | HC1 | HC3 | HC5 | ASTM Test Method |
|---|---|---|---|---|
| Thickness, micron | 36.3 | 46 | 48.3 | D5947-18, |
| | | | | Method D |
| Opacity, % | 63.6 | 67.5 | N/A | E1347 |
| MD Tensile Modulus, MPa | 253 | 286 | 451 | D882-18 |
| TD Tensile Modulus, MPa | 246 | 233 | 248 | D882-18 |
| MD Secant Modulus, MPa | 239 | 275 | 401 | D882-18 |
| TD Secant Modulus, MPa | 259 | 236 | 266 | D882-18 |
| MD Elongation at Break, % | 286 | 155 | 197 | D882-18 |
| TD Elongation at Break, % | 82 | 54 | 196 | D882-18 |
| MD Tensile Strength, MPa | 29 | 17 | 22 | D882-18 |
| TD Tensile Strength, MPa | 14 | 11 | 13 | D882-18 |
| MD Tear Strength, g | 157 | 66 | 69 | D1922-09 |
| TD Tear Strength, g | 144 | 96 | 75 | D1922-09 |
| PLA Content, % | 0 | 10 | 20 | |
| Compostability | Good | Marginal | Fail | |

### Example 8: Facestock Film Formulations Examples 1-6

Table 5 provides the list of components (in pre-mixture weight percentages) for six facestock film formulations:

TABLE 5

| | | | | | | | Ex-6A | |
|---|---|---|---|---|---|---|---|---|
| | | | | | | | Outer | Ex-6B |
| Supplier | Component Name | Ex-1 | Ex-2 | Ex-3 | Ex-4 | Ex-5 | layers | Core |
| PTT MCC Biochem | BioPBS FD92PM (wt. %) | 76 | — | 87 | — | — | — | 88 |
| Company Limited | (bio-based polybutylene | | | | | | | |
| | succinate (PBS) | | | | | | | |
| Biome Bioplastics | Bioplast 300 (wt. %) | — | 80 | — | 91 | 80 | 90 | — |
| Limited | (PBAT carrier and potato | | | | | | | |
| | starch) | | | | | | | |
| Colortech | 110LM7999 Home | — | 20 | 9 | 9 | 10 | 10 | 10 |
| | Compostable White (wt. %) | | | | | | | |
| | (70% rutile TiO2) | | | | | | | |
| Biome Bioplastics | DP852 (wt. %) | — | — | — | — | 10 | — | — |
| Limited | | | | | | | | |
| PTT MCC Biochem | MB92AM (wt. %) | 2 | | 2 | — | — | — | 2 |
| Company Limited | (Anti-Oxidant | | | | | | | |
| | Masterbatch) | | | | | | | |
| PTT MCC Biochem | MB92SM( wt. %) | 2 | | 2 | — | — | — | — |
| Company Limited | (Slip, Anti-Block | | | | | | | |
| | Masterbatch) | | | | | | | |

Table Note:
PBS - produced from polymerization of bio-based succinic acid and 1,4-butanediol.

### Example 9—Test Properties of Films Formed from the Facestock Formulations Examples 1-6

TABLE 6

| | | | | | Ex-6 | |
|---|---|---|---|---|---|---|
| | Target | | | | (co-extruded | Test |
| Property | Value | Ex-1 | Ex-2 | Ex-5 | 6A-6B-6A) | Method |
| Thickness, | 35-40 | 38 | 38 | 38 | 38 | ASTMD |
| micron | | | | | | 6400 |
| Opacity, % | 75 +/− | 85 | 85 | 75 | 75 | Rhopoint |
| | | | | | | Novo- |
| | | | | | | Shade |
| | | | | | | Duo+ |
| MD Tensile | 2500- | 4910 | 2090 | 2670 | 4560 | ASTM |
| Strength at | 5000 | | | | | D 882 |
| Break, psi | | | | | | |
| TD Tensile | | 4280 | 1350 | 1660 | 2940 | ASTM |
| Strength at | | | | | | D 882 |
| Break, psi | | | | | | |
| MD Elongation | | 450 | 460 | 250 | 480 | ASTM |
| at Break, % | | | | | | D 882 |
| TD Elongation | >210 | 810 | 360 | 210 | 660 | ASTM |
| at Break, % | | | | | | D 882 |
| MD Secant | 30,000- | 41200 | 32500 | 53000 | 34600 | ASTM |
| Modulus - 1% | 60,000 | | | | | D 882 |
| Secant, psi | | | | | | |
| TD Secant | | 55800 | 23400 | 31300 | 37600 | ASTM |
| Modulus - | | | | | | D 882 |
| 1% Secant, psi | | | | | | |

Table Notes:
Example Ex-3 and Ex-4 had an opacity measurements of 75%
Example 6A and 6B were co-extruded in an A-B-A configuration for a total thickness of 38 microns (15-70-15 thickness ratio).

Labels were constructed from facestock films by applying PSA adhesive (weight approx. 18 g/m²) and protective silicone liner (backer) to the back surface of the facestock film. Table 7 presents the results of field tests on these labels:

TABLE 7

| Labels Formed From the Film Formed From the | | | |
|---|---|---|---|
| Formulations of: | | Ex-1 | Ex-2 |
| Label Conversion Properties | | | |
| Ink Scuff Test | Pass/Fail | Pass | Pass |
| Ink Adhesion Test | Pass/Fail | Fail | Pass |
| Die Cutting Setting | | Heavy | Very Light |
| Matrix Breaks | Pass/Fail | Fail | Pass |
| | Acceptable | | |
| Converted Label Application Properties | Values | | |
| Pilot Plant/Lab Testing - | | | |
| Velcro Test (Adhesion Score) | <1.5 | 1.5 | 1.2 |
| Applicator Test Rig - Tape Break Test | <1 | 0 | 0 |
| Applicator Test Rig - Fliers Test | <20 | 15 | 18 |
| Testing (Avo, Apples, Green Kiwi) | | | |
| (approx. 10-30 produce items) | | | |
| Tray Labeling (Adhesion Score) T₀ | <1.5 | 1.3 | 1.1 |
| Tray Labeling (Adhesion Score) 1 hr | <1.5 | 1.25 | 1.1 |
| Tray Labeling (Adhesion Score) 1 day | <1.5 | 1.3 | 1.8 |
| Tray Labeling (Adhesion Score) 1 wk | <1.5 | 1.4 | 1.95 |
| Tray Labeling (Adhesion Score) 2 wks | <1.5 | 1.4 | 2.5 |
| Field Testing - Pack-house - Green Kiwi | | | |
| Percent Label | >95% | 98 | 99 |
| Adhesion Score | <1.5 | 1.3 | 1.3 |
| Flagging % Test | <10% | 16 | 21 |
| Field Testing - Pack-house - Gold Kiwi | | | |
| Percent Label | >95% | 99 | 99 |
| Adhesion Score | <1.5 | 1.1 | 1.2 |
| Flagging % Test | <10% | 3 | 4 |
| Field Testing - Post Shipping - Green Kiwi | | | |
| Percent Label | >95% | 98 | 97 |
| Adhesion Score | <1.5 | 1.4 | 1.7 |
| Flagging % Test | <10% | 11 | 21 |
| Field Testing - Post Shipping - Gold Kiwi | | | |
| Percent Label | >95% | 99 | 99 |
| Adhesion Score | <1.5 | 1.1 | 1.3 |
| Flagging % Test | <10% | 2 | 15 |

Ink Adhesion Test—Apply several printed labels (min. 3) to a piece of card stock for testing. Cover at least ⅔of the labels surface area with a strip of 3M 810 Scotch Magic Tape. Press the tape in place so no visible air bubbles remain. Wait at least 5 seconds and then peel tape off briskly at an angle of about 120 to 150 degrees. Re-apply the tape to an used portion of the card stock and visually inspect the tape for ink residue. Pass: No ink transferred to the tape. Fail: any readily visible ink on the tape.

Ink Scuff Test—Set a Sutherland 2000 Rub Tester to 5 rubs and speed 4 with a new scuff sheet attached to 2 lbs. weight. Apply several printed labels (min. 3) to a piece of card stock for testing. Apply 1-3 drops (total) of citrus oil on the printed portion of the labels. Wait a few seconds after applying drops and lower the 2 lbs. weight and press start on the Suttherland 2000 Rub Tester. Visually inspect the labels after the Rub Tester has stopped. Pass: test labels are free of any readily visible scuffs. Fail: Test labels have visually obvious scuffing of ink.

Percent Labeling Test—apply labels to a set of produce (for example: in field testing >1,000 units of gold or green kiwis) using a Sinclair High Speed labeling machine set at about 600-720 labels/minute speed. Then, visually inspect the labelled fruit to determine the percentage of fruit that had a label. Visually inspect fruit after labeling and note the time interval from time of labeling application, for example: immediately (T_{0,}), after 1-hour, after 1-week, etc.

Adhesion Score test—a series of labeled fruit (field testing a minimum >1,000 items of produce) is visually inspected for quality of label adhesion. The adhesion profile is given a score of from 1 to 5 according to FIG. 7 and any items missing a label are given a score of 10. The score is averaged over the series of labeled fruit tested, such that the score may take a decimal or fractional value. The lapsed time from time of labeling produce until visual test is noted and/or the point in the process of the label fruit is noted (for example, trays of labeled fruit, Pack-House is after the labeled fruit exits the packing line, Post Shipping is after the packed labelled fruit has at least been truck transported to another location). For example, a series of 5,000 labeled produce are scored in accordance with the Adhesion Score with 4,000 item scoring a 1 and 1,000 items scoring a 2—the Adhesion Score is 1.2.

Velcro Labeling Test—a series of labels (approx. 16) are applied onto a 3″ diameter roller covered with a loop material (from hook and loop Velcro) that mimics a kiwi surface. The labels in the roller are visually inspected in accordance with the Adhesion Score test.

Flagging % Test—visually inspect a series (in field testing minimum of >1,000 items) of labelled produce, after labeling in accordance with the Percent Labeling Test. Score the quality of the labelled fruit in accordance with the Adhesion Score Test (note: no value applied for produce that do not have a label). The Flagging % is the percentage of labelled produce having an Adhesion Score of 2 or greater. For example, a series of 5,000 labeled produce are scored in accordance with the Adhesion Score with 4,000 item scoring a 1 and 1,000 items scoring from 2-5—the Flagging % is 20%.

Tape Break Test—during the labeling of produce, in accordance with the Percent Labeling Test, the integrity of the silicon backer should be sufficiently intact such that it does not break and cause a stoppage.

Fliers Test—during the labeling of produce (minimum of 5 minutes of operation) in accordance with the Percent Labeling Test, visually inspected the dispensing operation to determine the number of labels not properly dispensed onto the bellows.

Die Cutting Setting Test—is a balance between overcutting into the backer (or silicone liner) and undercutting such that labels are removed along with the waste matrix. During the high-speed die cutting operation operators will adjust the cutting pressure to increase (Heavier) or decrease (Lighter) pressure on the cutting die. Ideally we want no labels going up the waste matrix while avoiding cutting through the silicon liner resulting in tape breaks.

### Example 10—Validation of Compostable Characteristics

An independent laboratory shall validate the label's ability to compost according to the industry home composting standards.

Heavy metal and fluorine analysis shall be tested in accordance with AS 4736:2006 and EN 13432. Heavy metal and fluorine analysis shall be defined as successful if the below values (PPM in total solids): arsenic (<5), selenium (0.75), mercury (<0.5), cadmium (<0.5), copper (<50), chromium (<50), molybdenum (<1), nickel (<25), lead (<50), zinc(<150), fluorine (<100).

Label disintegration shall be tested in accordance with the Aerobic Composting Method ISO 20200 and TUV Austria Belgium—OK Compost HOME Program, modification to EN 13432. Test environment shall be at a temperature of 25±° C. Disintegration shall be defined successful if after 180 days of controlled testing no more than 10% of the original dry matter remains after sieving with a 2.0 mm sieve.

Label biodegradation shall be tested in accordance with AS ISO 14855 and TUV Austria Belgium—OK Compost HOME Program, modification to EN 13432. Test environment shall be at an ambient temperature of 25±5° C. Biodegradation shall be defined successful if after 365 days of controlled testing at least 90% w/w (dry weight) in total or equal to the maximum degradation of a suitable reference substance.

Eco-toxicity shall be tested on both plants and earthworms. Eco-toxicity on plants shall be tested in accordance with Appendix E of EN13432, ISO 16929. Ecotoxicity on earthworms shall be tested in accordance with ASTM E1676. Eco-toxicity for plants shall be defined as successful after 14 days when germination rate and biomass are calculated as a percent meet or exceed that of the corresponding values obtained with the blank compost. Eco-toxicity for earthworms shall be defined as successful if after 14 days there is no greater than 10% difference in the morbidity or mean weight of surviving worms between the treated compost and the control.

Film shall meet AS 5810:2010 and TUV Austria Belgium—OK Compost HOME Program specification for home compostable materials. Disintegration defined by the above standards is that after a 180-day period no more than 10% of the original dry weight of the tested material shall fail to pass through a 2 mm sieve.

Biodegradation defined by the above standards is that after 365 days (AS 5810:2010) test period 90% of the organic carbon must be converted to carbon dioxide.

All publications and patent applications mentioned in this specification are herein incorporated by reference to the same extent as if each individual publication or patent application was specifically and individually indicated to be incorporated by reference. While preferred embodiments of the present invention have been shown and described herein, it will be obvious to those skilled in the art that such embodiments are provided by way of example only. It is intended that the following claims define the scope of the invention and that methods and structures within the scope of these claims and their equivalents be covered thereby.

1-285. (canceled).

286. A home compostable composition comprising:
75% to 90% by weight of a biodegradable polymer;
10% to 20% by weight of a coloring additive; and
up to 5% by weight of an anti-blocking agent;
wherein the biodegradable polymer is polybutylene succinate adipate (PBSA), polybutylene adipate terephthalate (PBAT) or a thermoplastic material that contains natural potato starch and other biologically sourced polymers.

287. The home compostable composition according to claim 286, wherein the thermoplastic material is a mixture of a biologically sourced polymer and greater than 20 wt. % potato starch.

288. The home compostable composition according to claim 286, wherein the home compostable composition contains less than 5% by weight of polylactic acid (PLA).

289. The home compostable composition according to claim 286, wherein the coloring additive is a titanium dioxide.

290. The home compostable composition according to claim 286, wherein the coloring additive further comprises a biodegradable carrier resin.

291. A method for manufacturing a label comprising:
co-extruding a multilayer film from the home compostable composition according to claim 286, said film comprising
a core layer,
a first skin layer positioned directly adjacent a first surface of the core layer, and
a second skin layer positioned directly adjacent a second surface of the core layer, and
said film is home compostable; and
applying a layer of an adhesive to at least a portion of a surface of the multilayer film.

292. A home compostable composition comprising:
a first biodegradable polymer composition comprising a first biodegradable polymer and natural potato starch, wherein the first biodegradable polymer has a glass transition temperature of less than 0° C.;
a second biodegradable polymer composition having a second biodegradable polymer with a glass transition temperature above 25° C.; and
5 to 10% by weight of titanium dioxide.

293. The home compostable composition according to claim 292, wherein the first biodegradable polymer is a thermoplastic material.

294. The home compostable composition according to claim 292, wherein the first biodegradable polymer composition is plasticizer-free.

295. The home compostable composition according to claim 292, wherein the first biodegradable polymer composition contains greater than 30 wt. % of renewable materials, relative to the total weight of the biodegradable polymer composition.

296. The home compostable composition according to claim 292, wherein the first biodegradable polymer composition contains a biobased carbon share of greater than 30 wt. %.

297. The home compostable composition according to claim 292, wherein the second biodegradable polymer composition comprises polylactic acid (PLA).

298. The home compostable composition according to claim 297, wherein the polylactic acid (PLA) is biologically sourced.

299. A non-cellulosic home compostable food produce label comprising blown-extrusion film formed from the home compostable composition of claim 292.

300. The non-cellulosic home compostable food produce label according to claim 299, wherein the film has a thickness of 35 to 45 micron.

301. A non-cellulosic home compostable food produce label suitable for high speed label machines comprising 35 to 45 micron thick home-compostable blown-extrusion film formed from a blend of polymers comprising:
(i) greater than 50 wt. %, relative to the total weight of the blend of polymers, of a plasticizer-free thermoplastic material comprising:
(a) greater than 50 wt. %, relative to the total weight of the thermoplastic material, of biologically sourced carrier-polymer, and
(b) between 25 wt. % to 40 wt. %, relative to the total weight of the thermoplastic material, of natural starch, and the thermoplastic material having greater than 30 wt. %, relative to the total weight of the thermoplastic material, of renewable raw materials and a biobased carbon share of the thermoplastic material exceeds 30%, wherein the thermoplastic material has a glass transition temperature of less than 0° C.; and
(ii) between 5 wt. % and 50 wt. %, relative to the total weight of the blend of polymers, of a second polymer composition comprising
(a) greater than 50 wt. %, relative to the total weight of the second polymer composition, of a carrier polymer selected from the group consisting of polybutylene adipate terephthalate (PBAT), polylactic acid (PLA), polybutylene succinate (PBS), or a mixture thereof;
(b) between 5 and 50 wt. %, relative to the total weight of the second polymer composition, of a stiff polymer having a glass transition temperature greater than 20° C.

302. The non-cellulosic home compostable food produce label according to claim 301, wherein the biologically-sourced carrier polymer is polybutylene adipate terephthalate (PBAT), polylactic acid (PLA), polybutylene succinate (PBS), or a mixture thereof.

303. The non-cellulosic home compostable food produce label according to claim 301, wherein the natural starch is a starch derived from is natural potato, corn, pea, tapioca, or rice or mixtures thereof.

304. The non-cellulosic home compostable food produce label according to claim 301, wherein the carrier polymer has a glass transition temperature of less than 0° C.

305. The non-cellulosic home compostable food produce label according to claim 301, wherein the blend of polymers comprises less than 8 wt. % of the stiff polymer.
